(19) United States
(12) Patent Application Publication
(10) Pub. No.: US 2012/0314445 A1
(43) Pub. Date: Dec. 13, 2012

(54) LIGHT GUIDE SET, ILLUMINATION DEVICE AND DISPLAY DEVICE

(75) Inventor: Takeshi Masuda, Osaka-shi (JP)

(73) Assignee: SHARP KABUSHIKI KAISHA, Osaka-shi, Osaka (JP)

(21) Appl. No.: 13/580,200

(22) PCT Filed: Nov. 18, 2010
(86) PCT No.: PCT/JP2010/070539

§ 371 Date: Aug. 21, 2012

(30) Foreign Application Priority Data
Mar. 11, 2010 (JP) 2010-054307

(51) Int. Cl. F21V 8/00

(52) U.S. Cl. 362/581

(57) ABSTRACT

In order for a light guide set including a light source such as an LED and a light guide member receiving light without leakage of light from the light source or the like to be provided, in the light guide set (ST) that includes an LED (32) and an light guide bar (11) which includes a light reception end (12R) receiving light from the LED (32) and which guides the received light and a holding member (25) which holds the LED (32) and the light reception end (12R) thereof on the side of the LED (32), a protrusion (11P) (a second engagement portion/a first engagement portion) is formed in the light guide bar (11), and an opening hole (26Dh) (the first engagement portion/the second engagement portion) is formed in the holding member (25).

### TECHNICAL FIELD

The present invention relates to a light guide set including at least a light source and a light guide bar for guiding light, an illumination device incorporating a light guide set and a display device incorporating an illumination device.

### BACKGROUND ART

In general, a liquid crystal display device (display device) incorporating a non-light emission liquid crystal display panel (display panel) includes a backlight unit (illumination device) that supplies light to the liquid crystal display panel. The backlight unit preferably generates planar light that spreads over the entire region of the planar liquid crystal display panel. Hence, the backlight unit may include a light guide member for mixing, to a high degree, the light of a light source (for example, a light emitting element such as an LED) incorporated.

For example, in the backlight unit of patent document 1, as shown in FIG. 41, light guide bars 111 are aligned in one direction, and LEDs 132 are arranged to respectively correspond to the light guide bars 111 (the LEDs 132 are mounted on a mounting substrate 131, and are held in a cylindrical reflector 125). As shown in the plan view of FIG. 42 and the cross-sectional view of FIG. 43, a backlight chassis 142 having a frame 142A holds the aligned light guide bars (light guide members) 111 and the mounting substrate 131 on which the LEDs 132 are mounted (a set that includes at least the LEDs 132 and the light guide bars 111 is referred to as a light guide set st).

### RELATED ART DOCUMENT

### Patent Document

Patent document 1: JP-A-2007-227074

### DISCLOSURE OF THE INVENTION

### Problems to be Solved by the Invention

Incidentally, the light guide bars 111 and the LEDs 132 are not connected directly or indirectly. Specifically, part of the frame 142A parallel to the bottom surface 142B of the backlight chassis 142 only presses LED modules mj and the light guide bars 111. Hence, the LEDs 132 are likely to be displaced with respect to the light guide bars 111. If such an event occurs, it is likely that light from the LEDs 132 sufficiently does not enter the light guide bars 111.

The present invention is made in view of the foregoing conditions. An object of the present invention is to provide a light guide set or the like that includes a light source such as an LED and a light guide bar which receives light from the light source without leakage of the light.

### Means for Solving the Problem

A light guide set includes: a light source; a light guide bar that includes a light reception end receiving light from the light source and that guides the received light; and a holding member that holds the light source and a side of the light reception end of the light guide bar. In the light guide set described above, among a first engagement portion and a second engagement portion that engage with each other, one of the engagement portions is formed in the light guide bar, and the other engagement portion is formed in the holding member.

In this configuration, the holding member simultaneously holds (retains) the light source and the light guide bar. Moreover, through the engagement portions, the light guide bar is stably fixed to the holding member. Hence, the light of the light source reliably enters the light guide bar through the light reception end. Consequently, the light guide set guides the light of the light source without leakage.

Preferably, the first engagement portion and the second engagement portion are also fitting portions that fit each other, and one of the engagement portions is convex, and the other engagement portion is so concave as to fit the convex engagement portion. In this configuration, the degree of the engagement is reliably enhanced.

Preferably, the holding member has a hollow, and the light source and a part of the light guide bar are held within the hollow. In this configuration, the light source and the light guide bar are in contact with the inner wall surface of the hollow of the holding member and thus are prevented from moving, with the result that the light of the light source reliably enters the light guide bar through the light reception end.

Preferably, the first engagement portion and the second engagement portion engage with each other such that the light reception end is separated from the light source placed at an end of the hollow of the holding member. In this configuration, the light guide bar and the light source are not in contact with each other, and thus they are prevented from being damaged.

Preferably, the holding member is an aggregation of a plurality of holding member parts, and the light source and the light guide bar are held in the holding member by being sandwiched between the holding member parts. In this configuration, the assembly of the light guide set is facilitated.

A clip that retains the light guide bar may be included. With this clip, when the light guide set is incorporated in, for example, the chassis of the illumination device, if the clip and the chassis engage with each other, the clip achieves the function of supporting the light guide bar.

Preferably, when the light guide bar includes: a light propagation portion that propagates the received light by reflecting the received light multiple times therewithin; and a light emission portion that emits the propagated light to the outside, the clip retains the propagation portion or the light emission portion.

Preferably, when a plurality of the light guide bars are provided, the light guide bars are coupled to each other through a coupling member. In this configuration, for example, when the group (light guide bar group) in which the light guide bars are continuously arranged is formed, it is possible to carry the light guide bar group (in short, it is possible to carry a large number of light guide bars at one time). Hence, the handling of the light guide bars is facilitated.

A clip that retains the coupling member may be included. Preferably, a part member along a direction in which the light guide bars extend is connected to the coupling member, and the clip catches the part member.

In this configuration, for example, even if the light guide bar is extended by the heat of the light source or other circuit components, the clip reliably catches the part member, and hence stably retains the light guide bar.

Preferably, in order to facilitate the handling, when a plurality of the light guide bars are provided, the holding members are integrally continuous.

An illumination device including: the light guide set described above; and a chassis that holds the light guide set is also said to be according to the present invention. An illumination device including: a diffusion plate that is supported by the surface of the holding member and that receives light from the light guide set; and an optical member that is supported by the diffusion plate and that transmits light from the diffusion plate is also said to be according to the present invention.

Preferably, in the illumination device, the holding member engages with the chassis and the clip also engages with the chassis such that the light guide bar is prevented from moving with respect to the chassis.

A display device including: the illumination device described above; and a display panel that receives light from the illumination device is also said to be according to the present invention.

### Advantages of the Invention

According to the present invention, since the positional relationship between the light source and the light guide bar is not changed, the light guide bar receives light without leakage of the light of the light source.

### BRIEF DESCRIPTION OF DRAWINGS

FIG. 1 An exploded perspective view showing light guide bars, a holding member and LED modules;

FIG. 2 A perspective view of the holding member;

FIGS. 3A to 3D FIG. 3A is a perspective view showing the LED modules supported by a support stage; FIG. 3B is a perspective view showing the LED modules sandwiched between a first holding member part and the support stage; FIG. 3C is a perspective view showing that the light guide bars are held in the grooves of the first holding member part; FIG. 3D is a perspective view showing that the light guide bars are pressed by a second holding member part;

FIG. 4 An exploded perspective view of a liquid crystal display device;

FIGS. 5A to 5C FIG. 5A is a cross-sectional view of the liquid crystal display device in FIG. 4, taken along line A-A′ and seen from arrows; FIG. 5B is a cross-sectional view of the liquid crystal display device in FIG. 4, taken along line B-B′ and seen from arrows; FIG. 5C is a cross-sectional view of the liquid crystal display device in FIG. 4, taken along line C-C′ and seen from arrows.

FIG. 6 A perspective view of a light guide bar group in a light guide unit;

FIG. 7 A perspective view of the light guide bar in the light guide bar group;

FIGS. 8A and 8B FIG. 8A is an enlarged view of the liquid crystal display device of FIG. 5C and is also an optical path diagram showing the optical path of light in the light guide bar; FIG. 8B is an enlarged view of the liquid crystal display device of FIG. 5B and is also an optical path diagram showing the optical path of light in the light guide bar;

FIG. 9 A diagram of another example of the liquid crystal display device of FIG. 5B and also an optical path diagram showing the optical path of light in the light guide bar;

FIG. 10 A diagram of another example of the liquid crystal display device of FIG. 5B and also an optical path diagram showing the optical path of light in the light guide bar;

FIG. 11 A diagram of another example of the liquid crystal display device of FIG. 5B and also an optical path diagram showing the optical path of light in the light guide bar;

FIG. 12 A diagram of another example of the liquid crystal display device of FIG. 5B and also an optical path diagram showing the optical path of light in the light guide bar;

FIGS. 13A and 13B FIG. 13A is a perspective view of the light guide bar in the light guide unit; FIG. 13B is a cross-sectional view of the light guide unit of FIG. 13A, taken along line B-B′ and seen from arrows and is also an optical path diagram showing the optical path of light in the light guide bar;

FIG. 14 A diagram of another example of the light guide unit of FIG. 13A and also a perspective view of the light guide bar in the light guide bar group;

FIG. 15 A plan view of the light guide unit;

FIG. 16 A perspective view of the light guide bar group;

FIG. 17 A plan view of the light guide unit;

FIG. 18 An enlarged plan view of the light guide bar;

FIGS. 19A and 19B FIG. 19A is a partial plan view of the light guide unit in which the arrangement distance of the light guide bar is equal to the arrangement distance of the light guide bar group; FIG. 19B is a partial plan view of the light guide unit in which the arrangement distance of the light guide bar is different from the arrangement distance of the light guide bar group;

FIG. 20 A plan view of the light guide unit;

FIG. 21 A plan view of the light guide unit;

FIG. 22 A perspective view of the light guide bar group in the light guide unit;

FIG. 23 A perspective view of the light guide bar in the light guide bar group;

FIGS. 24A and 24B FIG. 24A is a cross-sectional view of the liquid crystal display device and is also an optical path diagram showing the optical path of light in the light guide bar; FIG. 24B is a cross-sectional view of the liquid crystal display device and is also an optical path diagram showing the optical path of light in the light guide bar;

FIG. 25 A perspective view of the light guide bar in the light guide bar group;

FIG. 26 A cross-sectional view of the liquid crystal display device including the light guide bar shown in FIG. 25 and also an optical path diagram showing the optical path of light in the light guide bar;

FIG. 27 A perspective view of the light guide bar in the light guide bar group;

FIG. 28 A cross-sectional view of the liquid crystal display device including the light guide bar shown in FIG. 27 and also an optical path diagram showing the optical path of light in the light guide bar;

FIG. 29 A diagram of another example of the liquid crystal display device of FIG. 24B and also an optical path diagram showing the optical path of light in the light guide bar;

FIG. 30 A diagram of another example of the liquid crystal display device of FIG. 26 and also an optical path diagram showing the optical path of light in the light guide bar;

FIG. 31 A perspective view of the light guide bar group in the light guide unit;

FIG. 32 A plan view of the light guide unit;

FIG. 33 A two-diagram view showing together a partial plan view of the light guide unit including the light guide bar groups having different areas of the processing portions and a brightness distribution diagram of the light guide unit;

FIG. 34 A cross-sectional view showing a backlight chassis and a clip attached to the backlight chassis;

FIG. 35 A plan view showing the clips, light guide bars and the LEDs;

FIG. 36 A plan view showing the clips, light guide bars and the LEDs;

FIG. 37 A perspective view of the light guide bar group including coupling members;

FIG. 38 A plan view showing the light guide bars coupled with the coupling members, the clips and the LEDs;

FIG. 39 A plan view showing the light guide bars coupled with the coupling members, the clips and the LEDs;

FIG. 40 A plan view showing the light guide bars coupled with the coupling members, the clips and the LEDs;

FIG. 41 A perspective view showing light guide bars and the like in a conventional backlight unit;

FIG. 42 A plan view of the conventional backlight unit; and

FIG. 43 A cross-sectional view of the conventional backlight unit.

### DESCRIPTION OF EMBODIMENTS

### First Embodiment

An embodiment will be described below with reference to accompanying drawings. For convenience, member symbols and the like may be omitted; in that case, other drawings should be referenced. For convenience, a drawing other than a cross-sectional view may be hatched. A black dot shown together with arrows means a direction perpendicular to the plane of the figure.

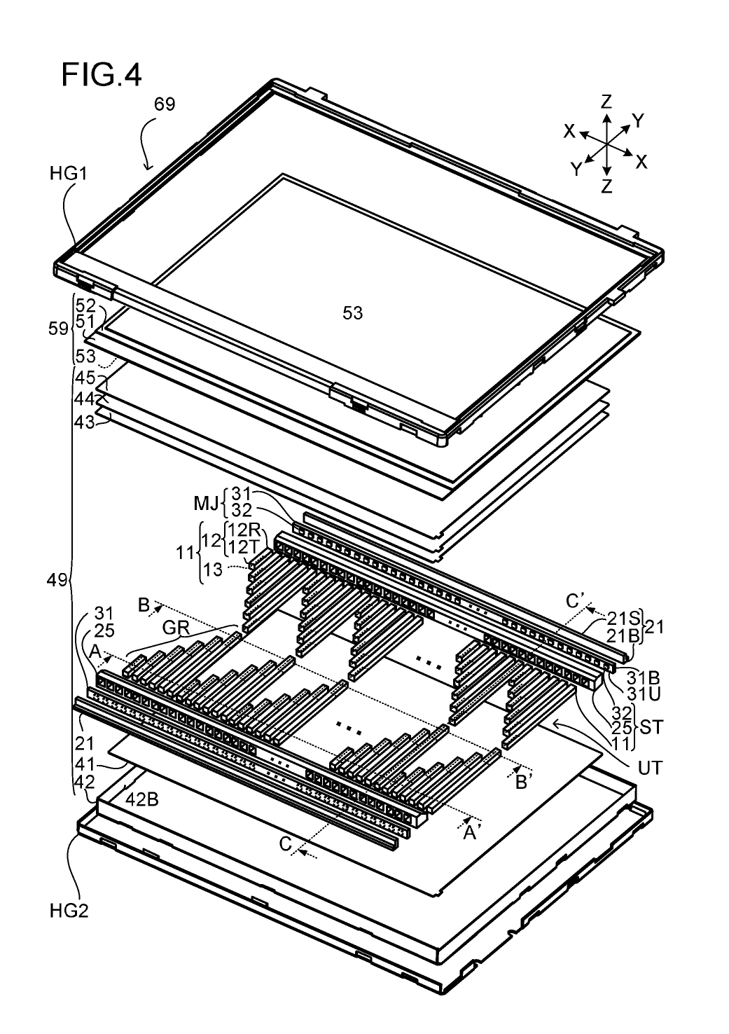

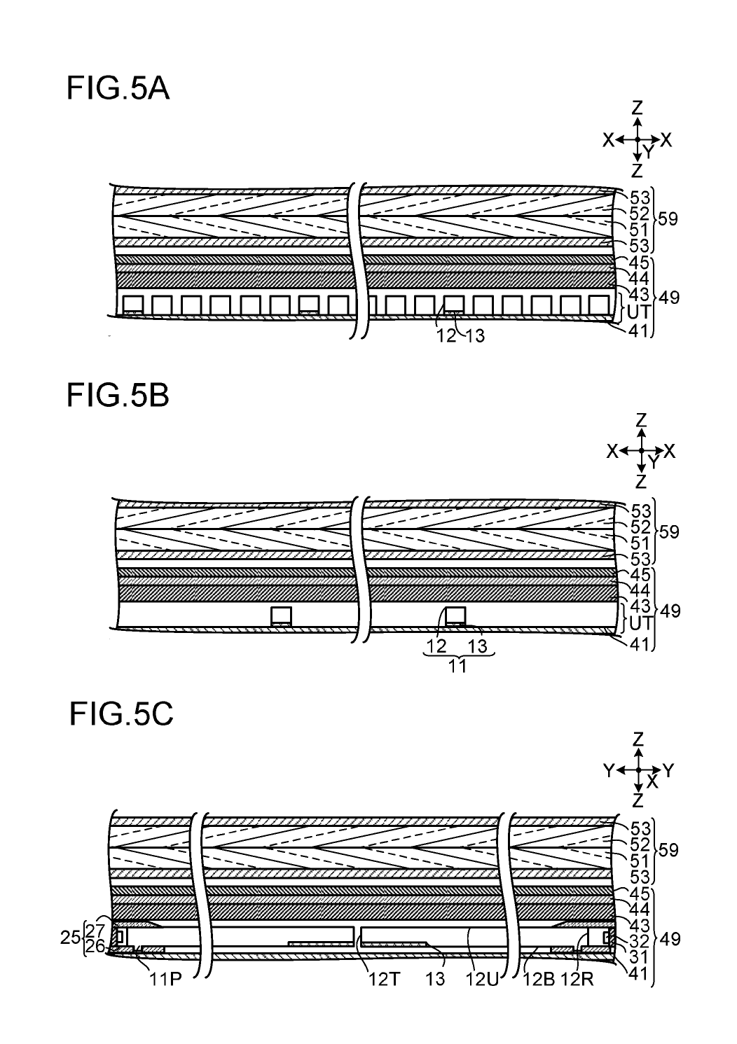

FIG. 4 is a schematic exploded perspective view showing a liquid crystal display device 69. FIG. 5A is a cross-sectional view of the liquid crystal display device 69 in FIG. 4, taken along line A-A′ and seen from arrows; FIG. 5B is a cross-sectional view of the liquid crystal display device 69 in FIG. 4, taken along line B-B′ and seen from arrows; FIG. 5C is a cross-sectional view of the liquid crystal display device 69 in FIG. 4, taken along line C-C′ and seen from arrows.

As shown in FIG. 4, the liquid crystal display device 69 includes: a liquid crystal display panel (display panel) 59; a backlight unit (illumination device) 49 that supplies light to the liquid crystal display panel 59; and a housing HG (a front housing HG1 and a rear housing HG2) that sandwiches these components.

In the liquid crystal display panel 59, an active matrix substrate 51 including switching elements such as TFTs (thin film transistors) and an opposite substrate 52 opposite the active matrix substrate 51 are adhered with a sealant (not shown). Liquid crystal (not shown) is injected into a gap between both the substrates 51 and 52.

Polarization films 53 are attached to the light reception surface side of the active matrix substrate 51 and the emission side of the opposite substrate 52. The liquid crystal display panel 59 described above utilizes variations in transmittance caused by the inclination of liquid crystal molecules, and displays an image.

The backlight unit 49 arranged directly below the liquid crystal display panel 59 will now be described. The backlight unit 49 includes LED modules (light source modules) MJ, light guide bars (light guide members) 11, a support stage 21, a holding member 25, a reflective sheet 41, a backlight chassis 42, a diffusion plate 43, a prism sheet 44 and a lens sheet 45.

The LED module MJ is a module that emits light, and includes a mounting substrate 31, and an LED (light emitting diode) 32 mounted on the substrate surface of the mounting substrate 31.

The mounting substrate 31 is a plate-shaped and rectangular substrate; on the mounting surface 31U, a plurality of electrodes (not shown) are arranged. The LEDs 32 are attached onto the electrodes described above. The backlight unit 49 includes two mounting substrates 31; the mounting substrates 31 are arranged such that the mounting surfaces 31U are opposite each other (a direction in which the mounting substrate 31 extends is referred to as an X-direction, a direction in which the two mounting substrates 31 are aligned is referred to as a Y-direction and a direction intersecting the X-direction and the Y-direction is referred to as a Z-direction).

The LED 32 is mounted on the electrodes (not shown) formed on the mounting surface of the mounting substrate 31, and thereby receives the supply of current to emit light. In order for a sufficient amount of light to be ensured, a plurality of LEDs (light emitting elements; point light sources) are preferably mounted on the mounting substrate 31. For convenience, in the figure, part of the LEDs 32 is only shown.

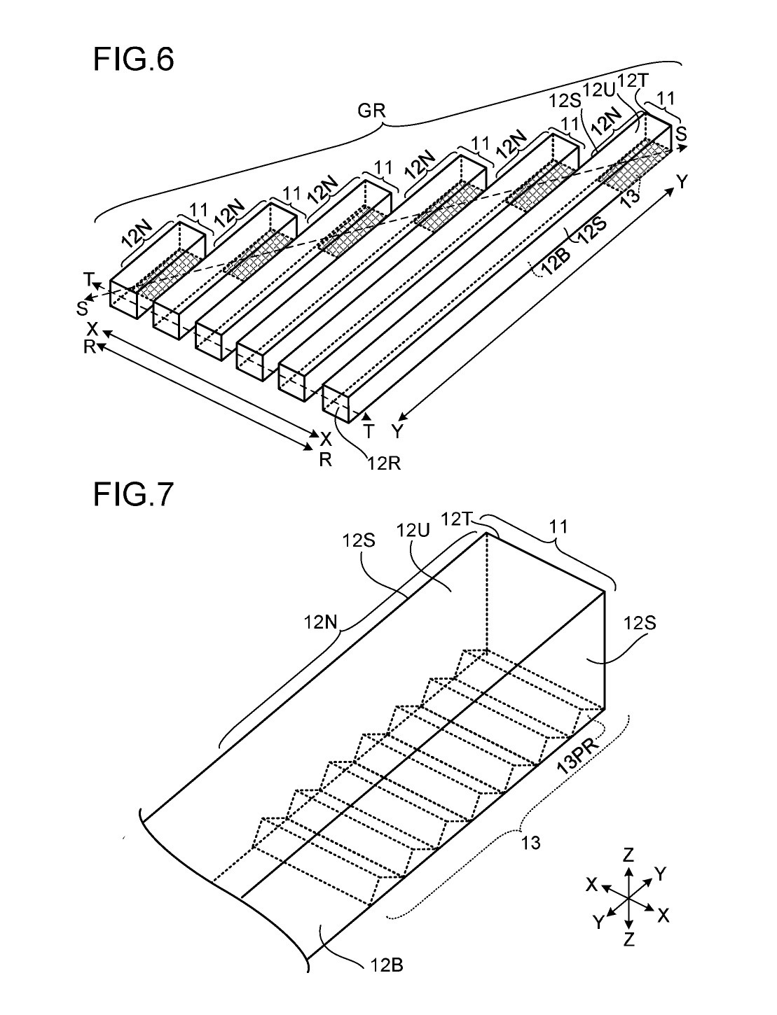

The light guide bar 11 is a bar-shaped member that is made of transparent resin such as acryl resin or polycarbonate, and receives light from the LED 32 to guide the light therewithin (to perform light guidance). Specifically, as shown in FIG. 6 and FIG. 7 (an enlarged view of FIG. 6), the light guide bar 11 is a light guide material that extends in the Y-direction and that is formed in the shape of a rectangular parallelepiped, and the light guide bars 11 are closely aligned along the X-direction (an aggregation of a plurality of light guide bars 11 described above is referred to as a light guide bar group GR).

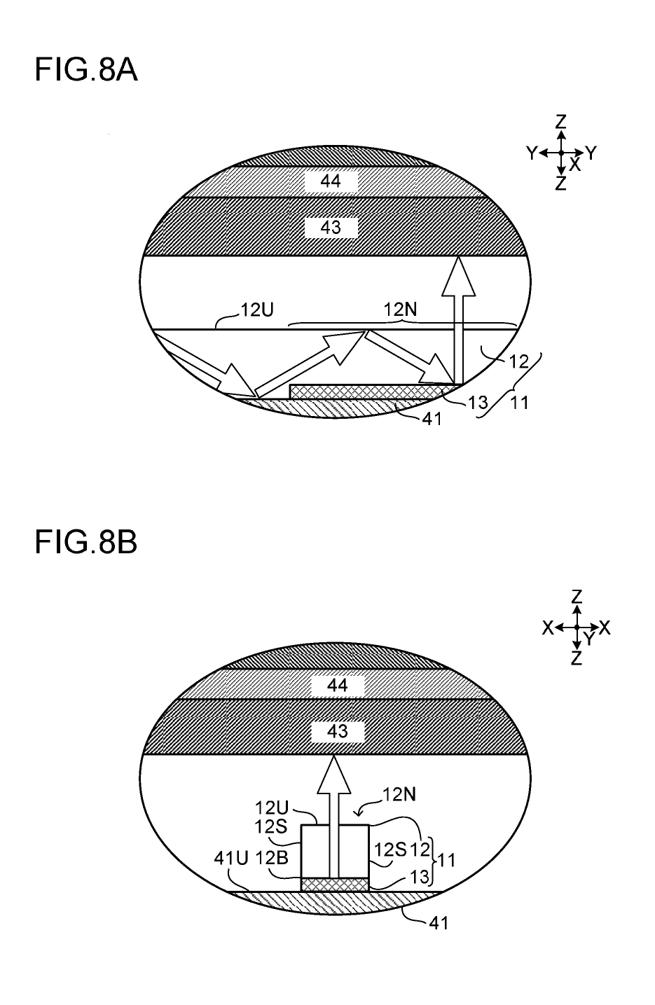

In the light guide bar 11, an end in the total length direction is referred to as a light reception end 12R that receives the light from the LED 32, and the other end in the total length direction, that is, the end on the opposite side of the light reception end 12R is referred to as a top end 12T (the area (the perimeter surrounding the light emission surface of the LED 32) of the LED 32 supplying light to the light reception end 12R of the light guide bar 11 is less than the area of the light reception end 12R). As shown in FIG. 8A, which is an enlarged view of FIG. 5C, the light guide bar 11 reflects the received light (see a white arrow) multiple times therewithin, and thereby propagates the light from the light reception end 12R to the top end 12T (a portion that propagates the light as described above is referred to as a light propagation portion 12).

Furthermore, the light guide bar 11 includes a processing portion 13 that changes the light propagating therewithin into an optical path suitable for emission to the outside (in short, an optical path is changed such that the light can be emitted through the side surface 12S of the light guide bar 11 without being totally reflected). This processing portion (optical path change processing portion) 13 is a surface in which, in the side of the top end 12T of the light guide bar 11, for example, as shown in FIG. 7, triangular prisms 13PR are aligned in the Y-direction.

However, the processing portion 13 is not limited to the prism processing portion 13 where the triangular prisms 13PR are arranged close to each other; the processing portion 13 may be either a portion that is subjected to graining processing or a portion that is subjected to dot-type printing processing (the processed surface is parallel to an arrangement plane direction in which a plurality of light guide bars 11 (a direction of an X-Y plane specified by the X-direction and the Y-direction) are aligned.

The portion that is subjected to the prism processing and the portion that is subjected to the graining processing reflect or refract and transmit the light and thereby change the direction of travel of the light, and prevent the side surface 12S of the light guide bar 11 from totally reflecting the light, with the result that the light is emitted to the outside. The portion that is subjected to dot-type printing processing is formed of, for example, white ink, and diffuses or reflects the light and thereby changes the direction of travel of the light, and prevents the side surface 12S of the light guide bar 11 from totally reflecting the light, with the result that the light is emitted to the outside (a portion of the light propagation portion 12 that includes the processing portion 13 and that covers the processing portion 13 is referred to as a light emission portion 12N).

As shown in FIG. 8B, which is an enlarged view of FIG. 5B, the processing portion 13 refracts the light and makes it travel at an angle of emission different from an incident angle of the light received (in short, changes the refraction angle of the propagated light; see white arrows), and thereby makes the light enter one surface of the light guide bar 11 at an angle less than a critical angle, with the result that the light is emitted to the outside (the critical angle is a critical angle unique to a light guide material). Then, light beams emitted from a plurality of light guide bars 11 overlap each other to form planar light.

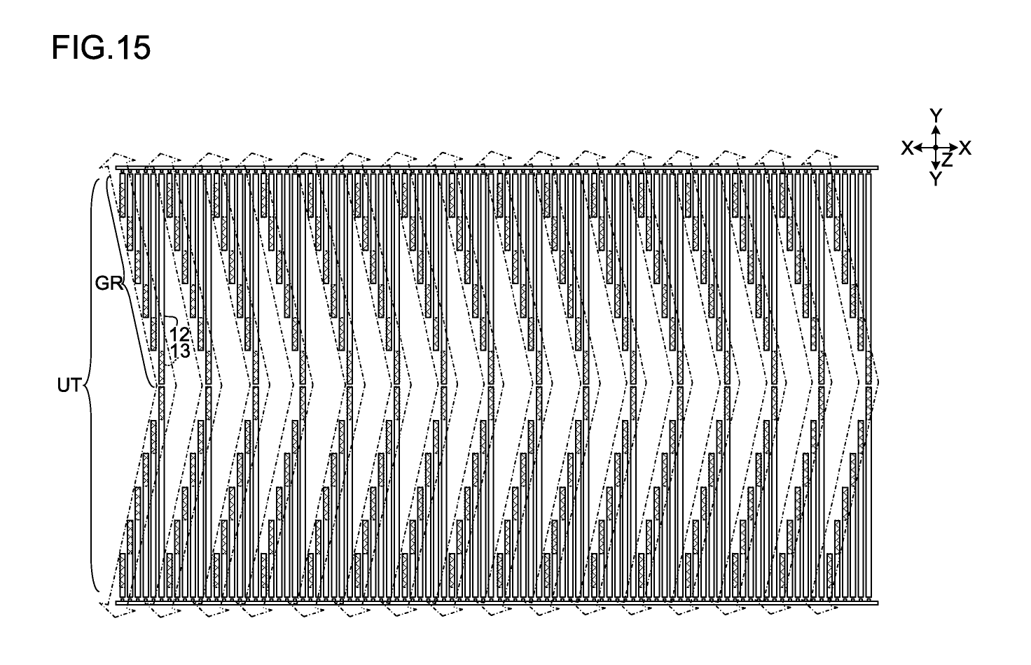

In the light guide bar group GR, in which, as described above, the light guide bars 11 guiding the light from the LEDs 32 are collected, a plurality of light guide bars 11 are arranged as shown in FIG. 6. Specifically, in the light guide bar group GR, the light guide bars 11 having different total lengths (for example, the total length is gradually increased) are aligned from one side to the other side in the X-direction; furthermore, a plurality of light guide bar groups GR are arranged along one of the mounting substrates 31 in the same direction in a repeated manner (see FIG. 15, which will be described later). Since the LEDs 32 are mounted along the X-direction, which is the direction of extension of the mounting substrate 31, in the light guide bar group GR, the light reception ends 12R are also aligned along the X-direction (a line that is obtained by connecting the positions of the light reception ends 12R is referred to as a light reception end arrangement line T or a T-direction).

The light guide bar groups GR aligned along one of the mounting substrates 31 and the light guide bar groups GR aligned along the other mounting substrate 31 are symmetric with respect to a line. In the following description, a collection of the light guide bar groups GR is referred to as a light guide unit UT (the number of light guide bar groups GR included in the light guide unit UT is not limited to two or more; the number can be one).

The support stage 21 is a stage that supports the LED modules MJ. The support stage 21 includes a side wall 21S that supports the non-mounting surface 31B (the back surface of the mounting surface 31U) of the mounting substrate 31 and a bottom wall 21B that is connected to the side wall 21S and that is fixed to the bottom surface 42B of the backlight chassis 42 (the fixing method is not particularly limited).

Specifically, the side wall 21S and the bottom wall 21B are continuous so as to form the shape of a letter L as seen from a cross section (an Y-Z plane direction) perpendicular to the longitudinal direction of the mounting substrate 31. Hence, when the bottom wall 21B of the support stage 21 is fixed to the bottom surface 42B of the backlight chassis 42, the side wall 21S rises with respect to the bottom surface 42B of the backlight chassis 42. Then, when the side wall 21S makes intimate contact with the non-mounting surface 31B of the mounting substrate 31 and supports it, the LEDs 32 on the mounting surface 31U can make the light travel along a direction within the plane of the backlight chassis 42 (X-Y plane direction).

The holding member 25 holds not only the LEDs 32 but also the side of the light reception end 12R of the light guide bar 11 (a collection of the LEDs 32, the light guide bars 11 and the holding member 25 is referred to as a light guide set ST). The holding member 25 may be a division-type, that is, may be formed with two members; for example, a first holding member part 26 and a second holding member part 27 are combined together to complete the holding member 25 (in short, an aggregation of the holding member parts 26 and 27 is the holding member). The holding member 25 will be described in detail later.

The reflective sheet 41 is a sheet that is covered by the bottom surfaces 12B (each of which is one surface of the four side surfaces 11S of the light guide bar 11) of a plurality of light guide bars 11; the reflective surface 41U of the sheet faces the bottom surfaces 12B of the light guide bars 11. When there is light that leaks from the bottom surfaces 12B of the light guide bars 11, the reflective sheet 41 reflects the light to return it to the light guide bars 11, and thus loss of the light is prevented (for convenience, in various drawings, the reflective sheet 41 may be omitted).

As shown in FIG. 4, the backlight chassis 42 is, for example, a box-shaped member; the LED modules MJ and the light guide units UT are closely arranged on the bottom surface 42B, and thus the backlight chassis 42 holds them.

The diffusion plate 43 is a plate-shaped optical member that covers the light guide units UT, and diffuses light emitted from the light guide units UT. Specifically, the diffusion plate 43 diffuses the planar light (in short, the light from the light guide units UT) formed by overlapping light from a plurality of light guide bars 11, and spreads the light over the entire region of the liquid crystal display panel 59 (the diffusion plate 43 may be placed between the surfaces (in particular, the pressing member 27M of the second holding member part 27, which will be described later) of the holding members 25 arranged opposite each other.

The prism sheet 44 is a sheet-shaped optical member that covers the diffusion plate 43. In the prism sheet 44, for example, triangular prisms extending in one direction (linearly) are aligned, within the sheet surface, in a direction intersecting the one direction. Thus, the prism sheet 44 changes the radiation characteristic of the light from the diffusion plate 43.

The lens sheet 45 is a sheet-shaped optical member that covers the prism sheet 44. In the lens sheet 45, minute particles for refracting and scattering light are dispersed therewithin. In this way, the lens sheet 45 prevents the light from the prism sheet 44 from being locally collected, and thereby reduces the contrast (variations in the amount of light).

In the backlight unit 49 described above, the light from a plurality of LED modules MJ is changed into the planar light by the light guide unit UT, and the planar light is transmitted through a plurality of optical members 43 to 45, and is supplied to the liquid crystal display panel 59. In this way, the non-light emission liquid crystal display panel 59 receives the light (backlight) from the backlight unit 49 to enhance the display function.

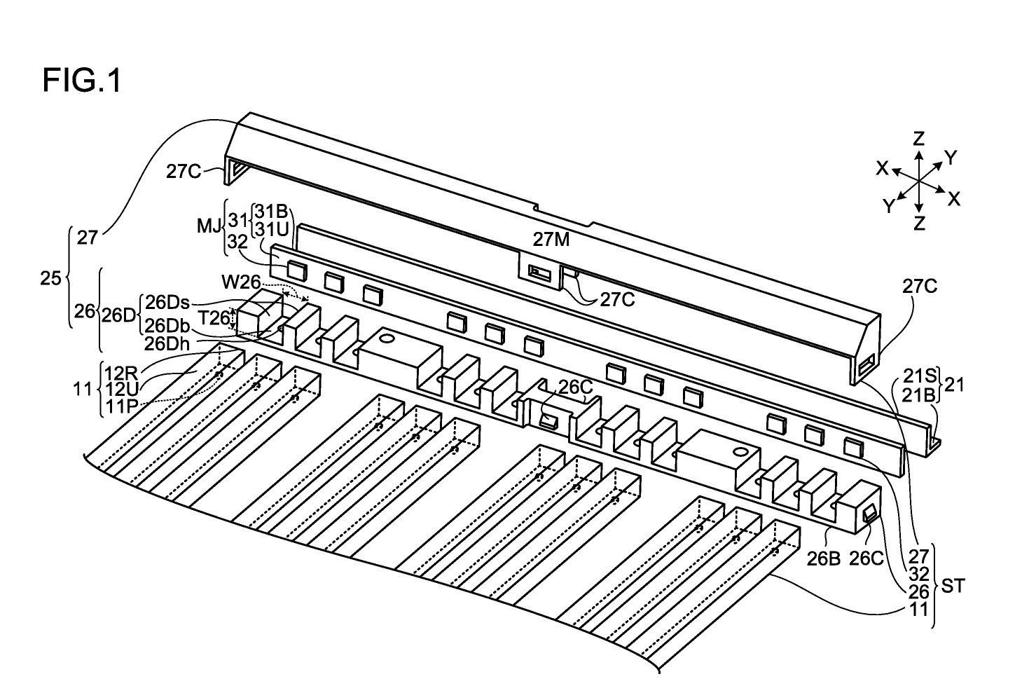

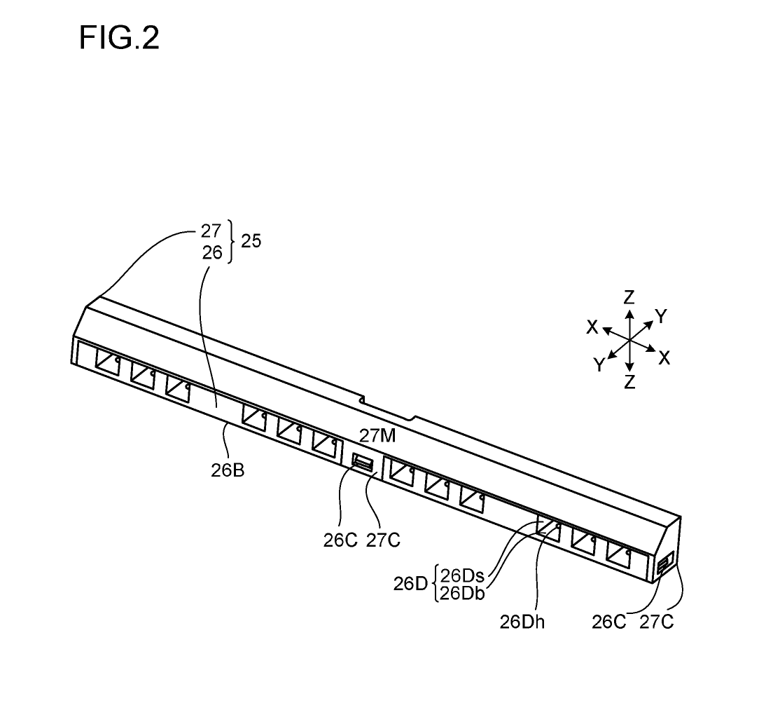

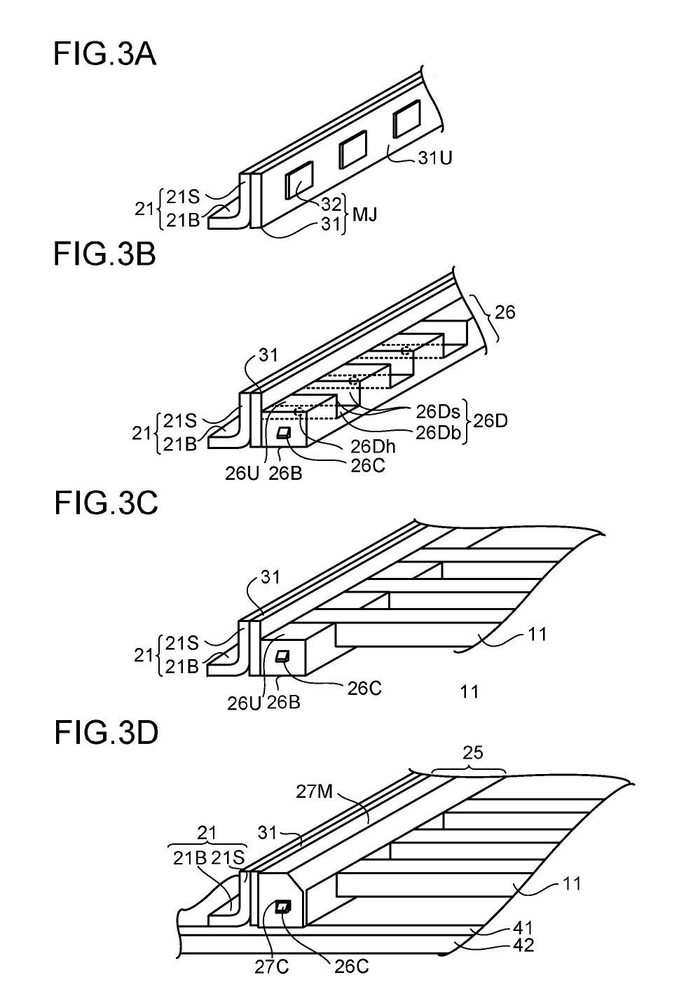

The holding member 25 will now be described with reference to FIGS. 1 to 3D. The exploded perspective view of FIG. 1 shows the holding member 25 and the light guide bars 11 and the LEDs 32 which are held in the holding member 25, and further shows the mounting substrate 31 on which the LEDs 32 are mounted and the support stage 21 supporting the mounting substrate 31. FIG. 2 is a perspective view of the holding member 25 that is completed by combining the two holding member parts 26 and 27. FIGS. 3A to 3D are perspective views showing the process of assembly of the light guide set ST.

The holding member 25 includes the first holding member part 26 and the second holding member part 27. The first holding member part 26 is bar-shaped, and has grooves 26D in a direction intersecting (for example, perpendicular to) a direction in which the bar extends. The groove 26D has a groove width W26 and a height T26 to such a degree that the light guide bar 11 is fitted into the groove 26D. Specifically, the groove 26D has substantially the same lengths as the bar width of the light guide bar 11 (a width in the X-direction (direction in which the light guide bars 11 are aligned) intersecting the direction in which the light guide bars 11 extend) and the height of the light guide bar 11 (a width in the Z-direction intersecting the direction in which the light guide bars 11 extend and the direction in which the light guide bars 11 are aligned).

The position of the groove bottom 26Db of the groove 26D (in short, a length from the groove bottom 26Db to the bottom surface 26B of the first holding member part 26) is determined as follows. Specifically, as shown in FIGS. 3A and 3B, when the LED modules MJ are supported by the support stage 21, and thus the LEDs 32 are made to face the grooves 26D of the first holding member part 26 (the bottom wall 21B of the support stage 21 and the bottom surface 26B of the first holding member part 26 are positioned on the same plane), the groove bottom 26Db of the groove 26D is lower than the end of the LED 32 closest to the bottom wall 21B. In this way, as shown in FIG. 3B, when the mounting surface 31U of the mounting substrate 31 makes intimate contact with the ends of the grooves 26D of the first holding member part 26, the LEDs 32 are held within the grooves 26D.

As shown in FIG. 3C, the grooves 26D hold the light guide bars 11. A design is made such that when, as described above the grooves 26D hold the light guide bars 11, the light guide bars 11 are prevented from being displaced in position with respect to the grooves 26D (hence, the first holding member part 26).

Specifically, an opening hole 26Dh (a first engagement portion or a second engagement portion) is formed in the groove 26D, and a protrusion 11P (the second engagement portion or the first engagement portion) that fits into the opening hole 26Dh is formed on the light guide bar 11. The opening hole 26Dh (concave fitting portion) and the protrusion 11P (convex fitting portion) described above engage with each other, and thus the light guide bars 11 are prevented from moving with respect to the first holding member part 26 and hence the holding member 25.

As shown in FIGS. 3C and 3D, the second holding member part 27 is a bar-shaped member that is continuous with the groove walls 26Ds of the first holding member part 26, that covers upper surfaces 26U parallel to the groove walls 26Ds and that are coupled to the first holding member part 26. Specifically, the second holding member part 27 includes: the pressing member 27M that extends in the same direction as the first holding member part 26; and second coupling portions 27C that are continuous with the pressing member 27M, that are coupled to the protrusive first coupling portions 26C of the first holding member part 26 and that are formed in the shape of an opening hole. With the second holding member part 27 described above, as shown in FIG. 3D, the first coupling portions 26C are coupled to the second coupling portions 27C, and thus the second holding member part 27 is fixed to the first holding member part 26.

Consequently, the LEDs 32 and the light guide bars 11 are simultaneously and stably held in the holding member 25 (especially, the grooves 26D) (in short, the holding member 25 covers, with the second holding member part 27, the first holding member part 26 having the grooves 26D, and thus the grooves 26D become hollow, and the LEDs 32 and part of the light guide bars 11 are held within the hollow).

Furthermore, the LED modules MJ are sandwiched between the support stage 21 and the holding member 25, and thus the LED modules MJ are prevented from moving with respect to the holding member 25; the protrusions 11P are fitted into the opening holes 26Dh of the holding member 25, and thus the light guide bars 11 are also prevented from moving with respect to the holding member 25. Hence, the LEDs 32 and the light guide bars 11 are unlikely to be changed in position (in the holding member 25, even if the LEDs 32 and the light guide bars 11 attempt to be moved, since they make contact with the inner wall surfaces of the hollow, variations in position are unlikely to be produced).

For example, even if the light guide bars 11 receive the heat of the LEDs 32 to expand, since the protrusions 11P are fitted into the opening holes 26Dh of the first holding member part 26, the light guide bars 11 do not move with respect to the holding member 25. Hence, the distance between the LED 32 positioned at the end of the hollow of the holding member 25 and the light reception end 12R of the light guide bar 11 is not changed (for example, the separation space between the LED 32 and the light reception end 12R is not changed). Therefore, the light reception end 12R is prevented from moving close to and making contact with the LED 32 due to the heat expansion of the light guide bar 11. By contrast, the light reception end 12R is prevented from being separated from the LED 32, with the result that the rate of entrance of light into the light reception end 12R is not reduced. In other words, the light of the LED 32 reliably enters the light guide bar 11 through the light reception end 12R, and the light guide bar 11 guides the light from the LED 32 without leakage.

Since the light from the LEDs 32 and the light from the light guide bars 11 may be incident on the holding member 25, the holding member 25 is preferably formed of reflective resin (for example, white polycarbonate) (in other words, the holding member 25 can be referred to as a reflector). As shown in FIG. 1, the first holding member part 26 and the second holding member part 27 sandwich the LEDs 32 of the LED modules MJ and the light guide bars 11, and thus it is possible to simplify the positioning of the LED modules MJ and the light guide bars 11 and thereby simplify the assembly of the light guide set ST.

The light guide unit UT will now be described in detail. In the light guide bar group GR of the light guide unit UT, as shown in FIG. 6, the light guide bars 11 having different total lengths are included. In the side of the top end 12T of the light guide bar 11, the processing portion 13 is formed (all the processing portions 13 are equal to each other in the length in the X-direction and the length in the Y-direction).

Then, the processing portions 13 are not aligned along the X-direction; they are aligned so as to intersect the X-direction (that is, the direction in which the light guide bars 11 are aligned; also referred to as an R-direction). In other words, as shown in FIG. 6, in the light guide bar group GR, a light emission portion arrangement line S that is formed by connecting the positions of the processing portions 13, that is, the positions of the light emission portions 12N including the processing portions 13 intersects the X-direction (that is, the light reception end arrangement line T).

In this way, even if the light reception ends 12R of the light guide unit UT are arranged near the ends that are non-display portions (for example, the perimeter of the liquid crystal display panel 59) in the liquid crystal display panel 59 of the liquid crystal display device 69, the light emission portions 12N for emitting light are placed in the inner side of the panel (for example, close to the vicinity of the center of the display panel) that is the display portion of the liquid crystal display panel 59. Hence, when the light guide unit UT described above is incorporated in the backlight unit 49, and therefore the liquid crystal display device 69, for example, a member for hiding the LEDs 32 is not needed.

Since the member described above is not present, the light of the light guide bars 11 emitted from the light emission portions 12N travels in a desired direction without being blocked, with the result that a loss of the light is not produced. Hence, when the light guide unit UT is incorporated in the backlight unit 49, the efficiency of utilization of the light is enhanced, and furthermore, the backlight unit 49 and therefore the liquid crystal display device 69 and the like are reduced in cost.

Moreover, when the light guide unit UT described above is used, the positions of the light emission portions 12N for emitting light are not close to each other, and they are appropriately arranged in a scattered manner. Hence, the following event is prevented; for example, the light from the light emission portions 12N becomes locally concentrated, the light does not spread to the other areas and planar light including variations in the amount of light is generated (in short, the light of the light guide bars 11 overlaps without being separated, and thus widespread planar light is formed). Therefore, the backlight unit 49 incorporating the light guide unit UT described above supplies high-quality backlight (planar light) to the liquid crystal display panel 59.

Since the light guide unit UT is made larger by further collecting the light guide bar groups GR that are the aggregations of the relatively small light guide bars 11, it is possible to acquire the amount of light suitable for a large backlight unit 49 (in short, by the number of light guide bars 11, the size of the light guide unit UT and the amount of light emitted from the light guide unit UT can be changed).

For example, when one light guide plate is used, a manufacturing mold needs to be changed according to the display area (that is, the display area of the liquid crystal display panel 59) of the liquid crystal display panel 59. However, in the light guide unit UT, since the number of light guide bars 11 or the number of the light guide bar groups GR can be changed without the manufacturing mold being changed, the light guide unit UT can cope with the display area of the liquid crystal display device 69. Hence, although the light guide unit UT is inexpensive, the light guide unit UT can be used for various types.

In the light guide unit UT, since light is not exchanged between the light guide bars 11, it is possible to control the emission of the light on each of the light guide bars 11. In other words, the emission of the light is controlled according to the light guide bars 11 of the light guide unit UT. Hence, the light guide unit UT can be said to be a member suitable for local dimming control (technology for locally controlling the amount of planar backlight).

As shown in FIG. 6, in the light guide bar group GR, a plurality of different total lengths of the light guide bars 11 are present. However, the present invention is not limited to this configuration. For example, among the six light guide bars 11 of the light guide bar group GR, two or more but less than light guide bars 11 having the same total length may be included. This is because, when the light guide bars 11 of at least two different total lengths are included, in the light guide bar group GR, it is possible to prevent the light from being aligned (arranged closely) in the direction in which the light reception ends 12R are aligned.

In other words, when a large number of types of light guide bars 11 having different total lengths included in the light guide bar group GR are present, for example, the light reception ends 12R of the light guide bars 11 are only aligned in a row, and thus the positions (that is, the positions of the processing portions 13) for emitting the light from the light guide bars 11 to the outside are prevented from being arranged along the direction in which the light reception ends 12R are aligned, and they are scattered. Hence, the light guide unit UT can simply guide the light in a direction intersecting the direction (X-direction) in which the light reception ends 12R are aligned. The length of the light guide bars 11 can be appropriately changed, and thus it is possible to easily change the distribution of the amount of light in the liquid crystal display panel 59.

Incidentally, as shown in FIGS. 6 and 8B, the processing portion 13 is planar, and the direction of the plane is parallel to the arrangement plane direction (X-Y plane direction) in which a plurality of light guide bars 11 are aligned (when the light reception side of the processing portion 13 faces the diffusion plate 43, the bottom surface 12B in which the processing portion 13 is formed and which is one of the side surface 12S is farthest away from the diffusion plate 43 as compared with the other side surfaces 12S). However, the plane direction of the processing portion 13 may intersect the X-Y plane direction (the plane direction of the reflective surface 41U).

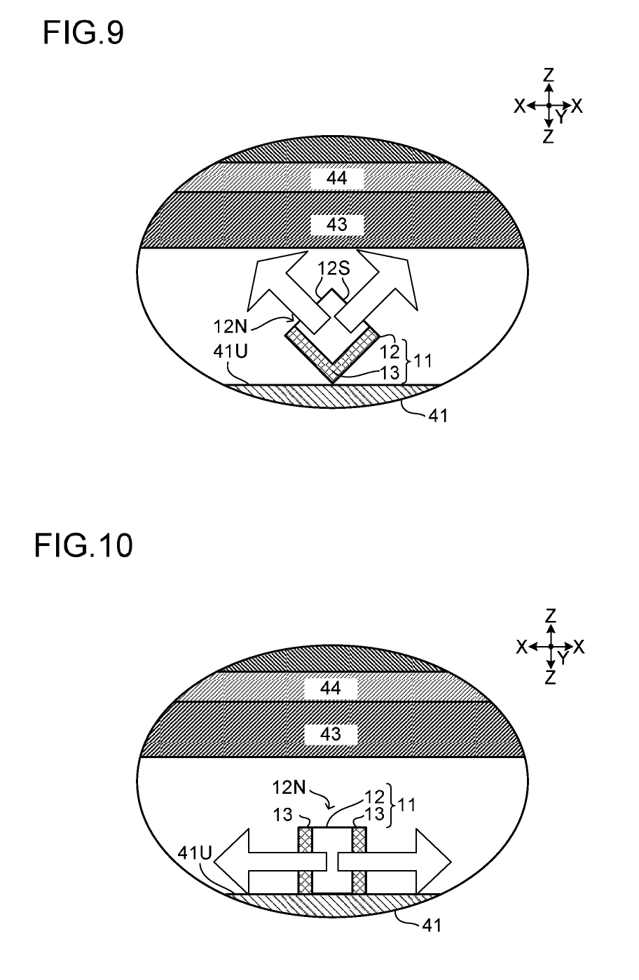

For example, when the processing portions 13 are formed in two continuous surfaces among the side surface 12S of the bar-shaped light guide bar 11, as shown in FIG. 9, the side surfaces 12S in which the processing portions 13 are formed are separated from the reflective surface 41U of the reflective sheet 41, and the connection portion between the two side surfaces 12S is preferably arranged to face the reflective surface 41U (when the light reception side of the processing portion 13 faces the diffusion plate 43, the two surfaces that are the side surfaces 12S in which the processing portions 13 are formed are farthest away from the diffusion plate 43 as compared with the other side surfaces 12S).

In this way, in light (see white arrows) shown in FIG. 9, as compared with light shown in FIG. 8B, the optical path from the processing portion 13 to the diffusion plate 43 is increased in length. In the case where the optical path is increased in length, when the widths of light beams shone on the diffusion plate 43 are compared, the light beam width of the light shown in FIG. 9 is increased as compared with the light beam width of the light shown in FIG. 8B. Consequently, the planar light shone on the diffusion plate 43 becomes light that is formed by overlapping the light from a plurality of light guide bars 11 in a widespread area and that has no variations in the amount of light, and thus the quality of the backlight is enhanced (in the liquid crystal display device 69 shown in FIGS. 8B and 9, the distance from the diffusion plate 43 to the processing portion 13 of the light guide bar 11 is greater than the distance from the reflective sheet 41 to the processing portion 13).

Preferably, when, as shown in FIG. 10, the processing portions 13 are formed in two separated (opposite) surfaces among the side surface 12S of the bar-shaped light guide bar 11, the side surfaces 12S in which the processing portions 13 are formed intersect the reflective surface 41U of the reflective sheet 41, and the side surface 12S in which no processing portion 13 is present is arranged to make contact with the reflective surface 41U. In this way, the planar light shone on the diffusion plate 43 becomes light that is formed by overlapping the light from a plurality of light guide bars 11 in a widespread area and that has no variations in the amount of light, and thus the quality of the backlight is enhanced.

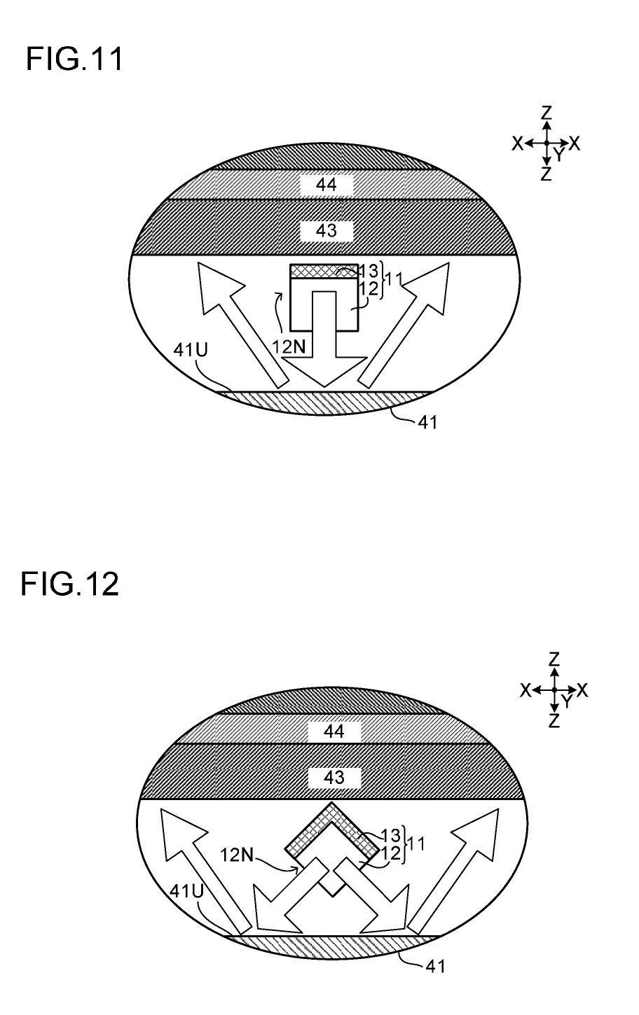

As shown in FIG. 11, the processing portion 13 is planar, and the light reception side (light reception surface) of the surface may face the reflective sheet 41 (specifically, the reflective surface 41U) (when the light reception side of the processing portion 13 faces the reflective sheet 41, one of the side surfaces 12S in which the processing portion 13 is formed is farthest away from the reflective sheet 41 as compared with the other side surfaces 12S). In this way, the light (see white arrows) shown in FIG. 11 travels from the processing portion 13 to the reflective sheet 41, is reflected off the reflective sheet 41 and thereafter reaches the diffusion plate 43. Hence, the optical path from the processing portion 13 to the diffusion plate 43 is reliably increased in length.

Moreover, when the distance from the reflective sheet 41 to the light guide bar 11 is longer than the distance from the diffusion plate 43 to the processing portion 13, the optical path of the light from the processing portion 13 is more reliably increased in length. Therefore, the planar light shone on the diffusion plate 43 becomes light that is formed by overlapping the light from a plurality of light guide bars 11 in a widespread area and that has no variations in the amount of light, and thus the quality of the backlight is enhanced.

Preferably, when the surface (light reception surface) of the processing portion 13 faces the reflective sheet 41 and the distance from the reflective sheet 41 to the processing portion 13 of the light guide bar 11 is longer than the distance from the diffusion plate 43 to the processing portion 13, and, as shown in FIG. 12, the processing portions 13 are formed in two continuous surfaces among the side surfaces 12S of the bar-shaped light guide bar 11, the two side surfaces 12S in which the processing portions 13 are formed are separated from the diffusion plate 43 of the reflective sheet 41, and the connection portion between the two side surfaces 12S is arranged to face (approach) the diffusion plate 43 (when the light reception side of the processing portion 13 faces the diffusion plate 43, the two surfaces that are the side surfaces 12S in which the processing portions 13 are formed are farthest away from the reflective sheet 41 as compared with the other side surfaces 12S). This is because, in this way, the optical path from the processing portion 13 to the diffusion plate 43 is reliably increased in length.

In short, when the light guide bar 11 is bar-shaped, the processing portion 13 is preferably formed on at least one side surface 12S among the side surfaces 12S of the bar (see FIGS. 8B and 9 to 12). In this way, the direction in which the light is emitted is easily changed according to the position of the side surface 12S in which the processing portion 13 is formed. The bar-shaped light guide bar 11 is only inclined (rotated about the Y-direction), and thus it is possible to easily change the direction in which the light from the light guide bar 11 is emitted and extend the optical path from the processing portion 13 to the diffusion plate 43.

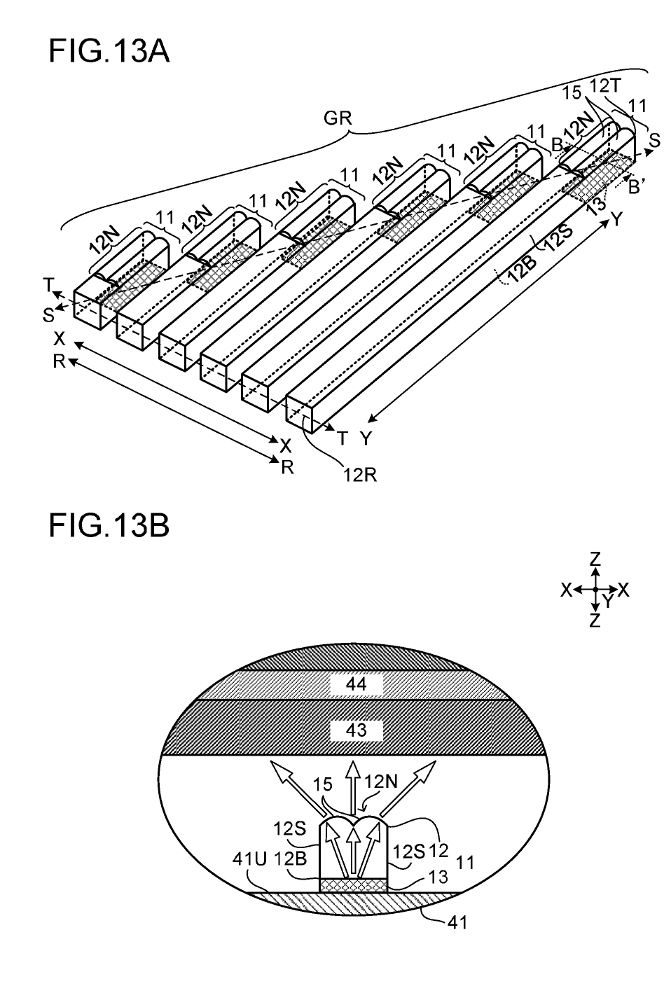

As shown in FIG. 13A and FIG. 13B (cross-sectional view taken along line B-B′ of FIG. 13A and seen from arrows), in the side surface 12S (also referred to as a top surface 12U) of the light guide bar 11 opposite the processing portion 13 of the light guide bar 11, a lens 15 for diffusing the light from the processing portion 13 may be formed. For example, two cylindrical lenses 15 may be formed in the top surface 12U of the light guide bar 11 (in a cross-sectional view along the X-Z plan direction specified by the X-direction and the Y-direction, the shape of the cylindrical lenses 15 is semicircular).

In this way, the light traveling from the processing portion 13 passes through the lenses (diffusion lenses) 15 and thus diffuses, and is emitted to the outside. Hence, for example, when the light enters the diffusion plate 43 arranged to cover the lenses 15, the light beam width of the light is increased. Then, the application area of the diffusion plate 43 to which light is applied is increased, a large number of application portions are overlapped and backlight including no variations in the amount of light is generated.

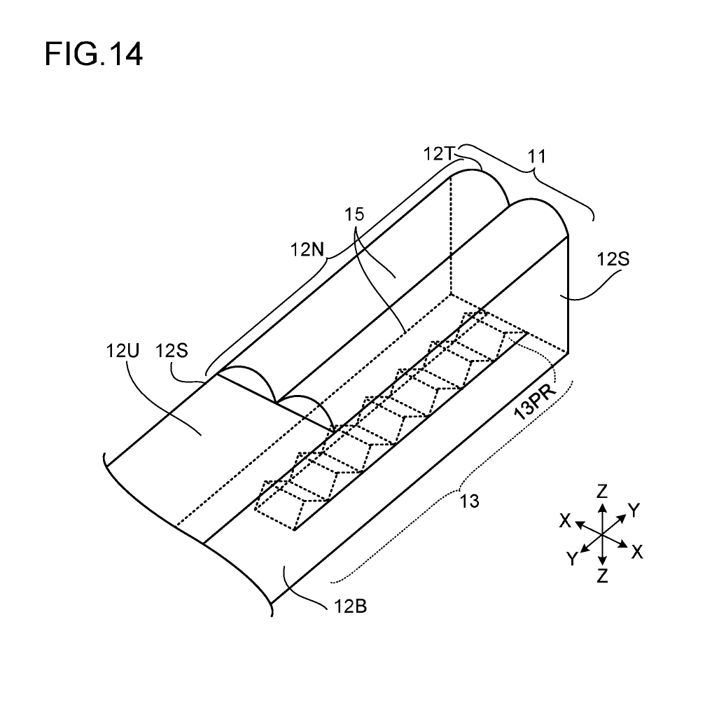

Preferably, in the light guide bar 11 including the lenses 15 described above, as shown in FIG. 14, the processing portion 13 is not formed in the entire bottom surface 12B (which is one of the side surfaces 12S of the light guide bar 11 and is the opposite surface of the top surface 12U) of the light guide bar 11 in the width direction (X-direction), and is formed only in the vicinity of the center of the width (in short, the processing portion 13 in the bottom surface 12B sandwiched between the side surfaces 12S aligned in the width direction of the light guide bar 11 is preferably formed to be separated from the side surfaces 12S).

This is because, even if the light enters parts of the lens surface near the side surfaces 12S sandwiching the top surface 12U, since the curvature of the lenses 15 is low, it is difficult to diffuse the light. In other words, parts of the processing portion 13 close to the side surfaces 12S that easily guide the light toward the parts of the lens surface close to the side surfaces 12S sandwiching the top surface 12U may be omitted. In this way, the cost for processing the processing portion 13 is reduced.

A description has been given of the case where the optical path of the light from the LED 32 is extended as much as possible, thus the degree to which the light is mixed is increased (in short, the light beams as large as possible are overlapped by increasing the length of the optical path and the size of the light beams) and high-quality planar light is generated. However, needless to say, in the backlight unit 49 where the light guide bars 11 are used, as compared with a direct-type backlight unit in which light is made to directly enter the diffusion plate from the LED, it is possible to extend the optical path. Hence, the backlight unit 49 incorporating the light guide unit UT can provide high-quality backlight.

Moreover, although, in the direct-type backlight unit, in order to increase the degree to which the light is mixed, it is necessary to increase the distance from the LED to the diffusion plate, the backlight unit 49 incorporating the light guide unit UT does not need it. Hence, since the distance from the diffusion plate 43 to the processing portion 13 is relatively short, the backlight unit 49 is thin.

### Second Embodiment

A second embodiment will be described. Members having the same functions as in the first embodiment are identified with like symbols, and their description will not be repeated.

As shown in the plan view of FIG. 15, in the light guide unit UT of the backlight unit 49 of the first embodiment, the light guide bar groups GR are arranged symmetrically, and the total length direction (Y-direction) of the light guide bar 11 is perpendicular to the direction (X-direction) in which the light reception ends 11R of the light guide bars 11 are aligned.

Hence, in the light guide bar groups GR facing each other along the Y-direction, the track of light obtained by connecting light from the processing portions 13 (hence, the light emission portions 12N) arranged on the side of the top ends 12T of the individual light guide bars 11 is, as shown in FIG. 15, a broken line (V-shaped) indicated by alternate long and short dashed lines. When the two opposite light guide bar groups GR described above are aligned along the X-direction, the tracks of the light in the shape of the broken line are also aligned along the X-direction.

Then, the light from the backlight unit 49 (that is, the light guide unit UT) has a slight displacement toward the bending point of the broken line; if the degree of the displacement is excessive, the backlight is likely to include variations in the amount of light. Since the track of the light in the shape of the broken line is not parallel to the longitudinal direction and the width direction of the liquid crystal display panel 59, the track is likely to become noticeable as a line of light (variations in the amount of light) due to visual characteristics.

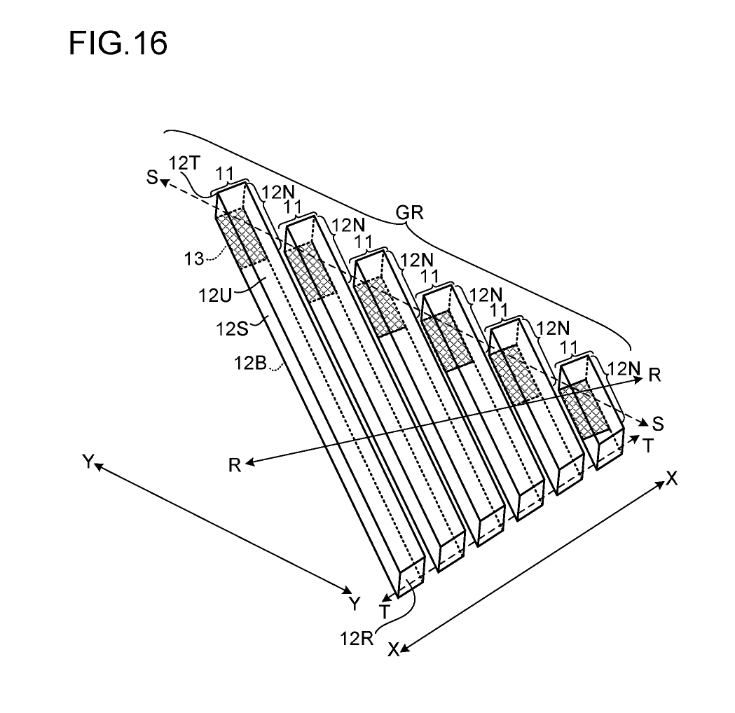

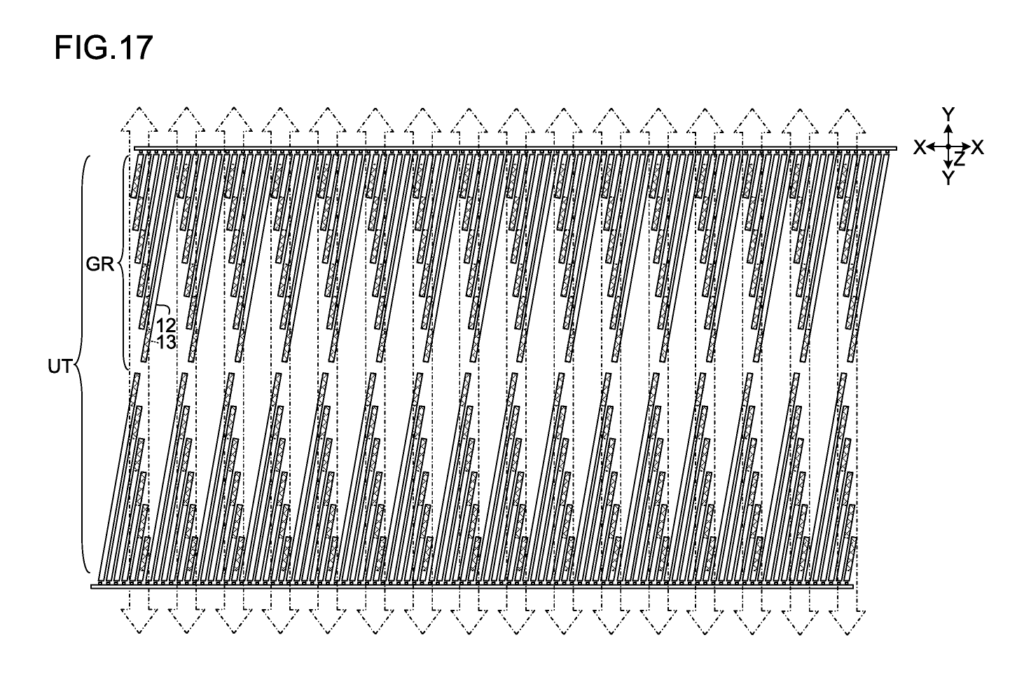

Hence, preferably, as shown in the perspective view of FIG. 16, in the light guide bar group GR, the light reception end arrangement line T formed by connecting the positions of the light reception ends 12R intersects the R-direction that is the direction in which the light guide bars 11 are aligned, and is perpendicular to the light emission portion arrangement line S formed by connecting the processing portions 13. For example, the light guide bars 11 having different total lengths (for example, the total length is gradually increased) are aligned such that the light reception ends 12R are along the X-direction. Furthermore, as shown in the plan view of FIG. 17, on the individual mounting substrates 31, the light guide bar groups GR are repeatedly arranged in the same direction from one side to the other side in the X-direction, and the light guide unit UT is arranged symmetrically with respect to a point.

In this way, since, as shown in FIG. 17, the light (see alternate long and short dashed lines) of the backlight unit 49 incorporating the light guide unit UT is not displaced, the backlight is unlikely to include variations in the amount of light. Moreover, when the light from the backlight unit 49 is supplied to the liquid crystal display panel 59, the light is along the Y-direction that is the width direction of the liquid crystal display panel 59. Hence, due to the visual characteristics, a user easily sees the liquid crystal display panel 59 (it is possible that the arrangement of the light guide unit UT is changed and thus the light from the backlight unit 49 is along the X-direction that is the longitudinal direction of the liquid crystal display panel 59).

However, in the light guide unit UT described above and shown in FIG. 17, there is a precondition that the light emission portion arrangement line S where the processing portions 13 for guiding the light are continuous is linear. Specifically, the arrangement of the light guide bar groups GR where the light emission portion arrangement line S is linear is changed variously, and thus it is possible to assemble either the light guide unit UT shown in FIG. 17 or the light guide unit UT shown in FIG. 15. Hence, the light guide unit UT including the light guide bar groups GR where the light emission portion arrangement line S is linear said to be suitable for the liquid crystal display device 69.

Incidentally, when the light enters the light guide bar 11 through the light reception end 12R, it is desirable to minimize the emission of the light from the light guide bar 11 while the light travels toward the top end 12T (in short, it is desirable to reduce the decrease in the amount of light reaching the processing portion 13). In particular, when, as shown in FIG. 16, in the light guide bar 11, the side surface 12S is not perpendicular to the flat surface (the light reception surface) of the light reception end 12R, the light travelling from the light reception end 12R to the top end 12T is likely to be emitted from the side surface 12S.

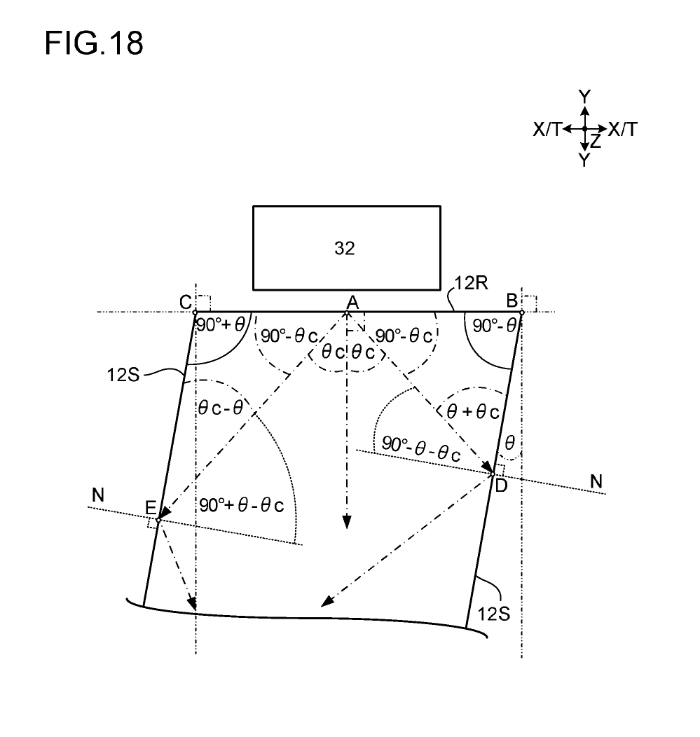

In order for this problem to be prevented, an inclination angle (θ°) of the side surface 12S is preferably set such that a relational formula reflecting the critical angle) (θc°) of the material of the light guide bar 11 is satisfied (see FIG. 18). The inclination angle refers to an angle that is formed with respect to the Y direction by at least part of the side surface 12S (specifically, the inside surface or the outside surface of the side surface 12S), for example, part of the side surface 12S which overlaps a T-Y plane specified by the T-direction in which the light reception ends 12R are aligned and the Y direction.

Here, a detailed description will be given with reference to FIG. 18, which is an enlarged plan view of the light guide bar 11. In the figure, the arrows of alternate long and short dashed lines mean light, and dashed lines N mean normals to the side surface 12S.

In general, when the light enters the flat surface of the light reception end 12R, the light does not have a refraction angle equal or more than the critical angle) (θc°) with respect to the flat surface of the light reception end 12R (it is assumed that the light reception point of the light reception end 12R is A point, that one of both ends of the light reception end 12R overlapped by the T-Y plane overlapping the A point is B point and that the other end is C point).

Then, when the light is incident on the side surface 12S including the B point, and the incident point of the side surface is assumed to be D point, an angle ABD, an angle BDA and an angle DAB are determined. Specifically,

angle ABD=90°−θ

angle BDA=θ+θc and

angle DAB=90°−θc.

Then, the incident angle of the light with respect to the side surface 12S including the B point becomes 90°−θ−θc. Preferably, in order for the light not to pass through the side surface 12S including the B point and exit to the outside, at the incident angle (90°−θ−θc) that is greater than the critical angle, total reflection is made to occur. That is, the following relational formula A is derived from 90°−θ−θc≧θc.

θ≦90°−2×θc (Relational formula A)

When the light is incident on the side surface 12S including the C point, and the incident point of the side surface 12S is assumed to be E point, the angle ACE, the angle CEA and the angle EAC are determined. Specifically,

angle ACE=90°+θ

angle CEA=θc−θ and

angle EAC=90°−θc.

The incident angle of the light with respect to the side surface 12S including the C point becomes 90°+θ−θc. The incident angle (90°+θ−θc) is prevented from becoming smaller than the critical angle. Hence, the light with respect to the side surface 12S including the C point is totally reflected.

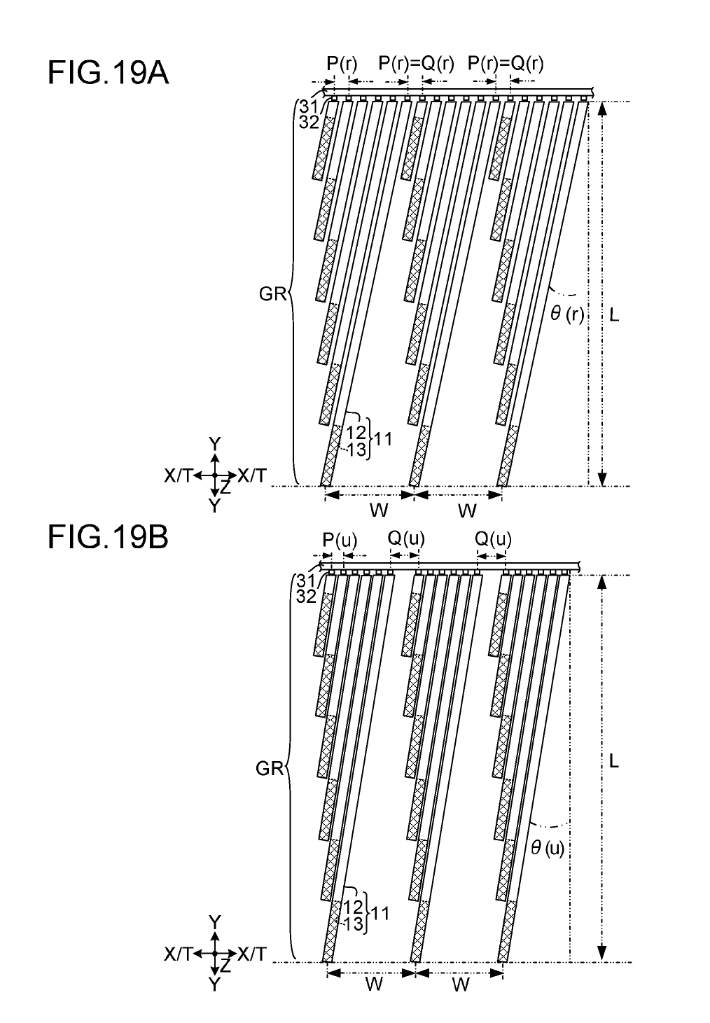

As shown in FIG. 19A, when it is assumed that an arrangement distance between the light guide bars 11 of the light guide bar group GR is an arrangement distance P, that a length from the light reception end 12R of the light guide bar 11 having the shortest total length to the top end 12T of the light guide bar 11 having the longest total length is length L (where the line having this length is parallel to the Y direction), that the number of light guide bars 11 of the light guide bar group GR is m and that the inclination angle of the side surface 12S of the light guide bar 11 is θ, the following relational formula B can be derived (for convenience, θ of FIG. 18A may be referred to as θ(r), and the arrangement distance P may be referred to as P (r)).

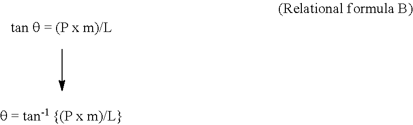

In FIG. 19A, as in FIG. 17, the arrangement distance P(r) between the light guide bars 11 of the light guide bar group GR is equal to the arrangement distance Q(r) of the light guide bar group GR. However, the present invention is not limited to this arrangement. For example, the light guide unit UT as shown in FIG. 19B may be used.

For example, when the arrangement distance W of the light guide bar group GR is assumed to be equal to the length L both in the light guide unit UT of FIG. 19A and in the light guide unit UT of FIG. 19B, as shown in FIG. 19B, the arrangement distance P(u) between the light guide bars 11 of the light guide bar group GR may be shorter than the arrangement distance P(r) between the light guide bars 11 of FIG. 19A {P(u)<P(r)}, and the arrangement distance Q(u) of the light guide bar group GR may be longer than the arrangement distance Q(r) of the light guide bar group GR of FIG. 19A {Q(u)>Q(r)}.

Then, when FIG. 19A and FIG. 19B are compared, in the light guide unit UT as shown in FIG. 19A, the relational formula B is as follows.

θ(r)=tan⁻¹ {(P(r)×m)/L} (Relational formula Ba)

On the other hand, in the light guide unit UT as shown in FIG. 19B, the relational formula B is as follows.

θ(u)=tan⁻¹ {(P(u)×m)/L} (Relational formula Bb)

Then, θ(u)<θ(r) is given by the relationship P(u)<P(r). In other words, when, in the light guide unit UT, a predetermined arrangement distance W of the light guide bar group GR and a predetermined length L (the length from the light reception end 12R of the light guide bar 11 having the shortest total length to the top end 12T of the light guide bar 11 having the longest total length) are determined, as shown in FIG. 19B, the arrangement distance Q(u) of the light guide bar group GR is made longer than the arrangement distance P(u) between the light guide bars 11, and thus it is possible to minimize the inclination angle θ of the light guide bars 11.

When the inclination angle θ is small as described above, in the process of the light travelling from the light reception end 12R to the top end 12T, the light is unlikely to be emitted from the side surface 12S without reaching the processing portion 13. Consequently, the light guide unit UT as shown in FIG. 19B is unlikely to loss light (in short, it is unlikely that the light guide unit UT cannot guide the light to the diffusion plate 43).

The following relational formula C can be derived from the relational formula A and the relational formula B.

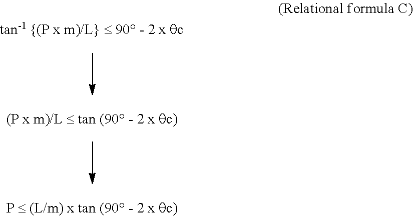

As is understood from what has been described above, the limit value of the inclination (the inclination angle θ) of the light guide bar 11 is determined depending on the critical angle θc, and furthermore, the arrangement distance P between the light guide bars 11 is determined to achieve such inclination.

### Third Embodiment

A third embodiment will be described. Members that have the same functions as in the first and second embodiments are identified with like symbols, and their description will not be repeated.

In the first and second embodiments, the light guide unit UT (see FIG. 15) in which the light guide bar groups GR are symmetrically arranged about a line and the light guide unit UT (see FIG. 17) in which the light guide bar groups GR are symmetrically arranged about a point are described as the example. However, the present invention is not limited to these arrangements.

For example, because of the visual characteristics of a person, the person can hardly sense the decrease in the brightness of the regions other than the center of the liquid crystal display panel 59 (in short, even if the brightness of the peripheral areas of the liquid crystal display panel 59 is somewhat decreased, the liquid crystal display panel 59 is recognized to have an uniform brightness). Then, when the backlight unit 49 emits planar light in which the brightness of the vicinity of the center of the liquid crystal display panel 59 is higher than that of the peripheral areas, the brightness of the liquid crystal display panel 59 is effectively increased (for example, the liquid crystal display device 69 can provide an image of high brightness to the user even if the power consumption is limited).

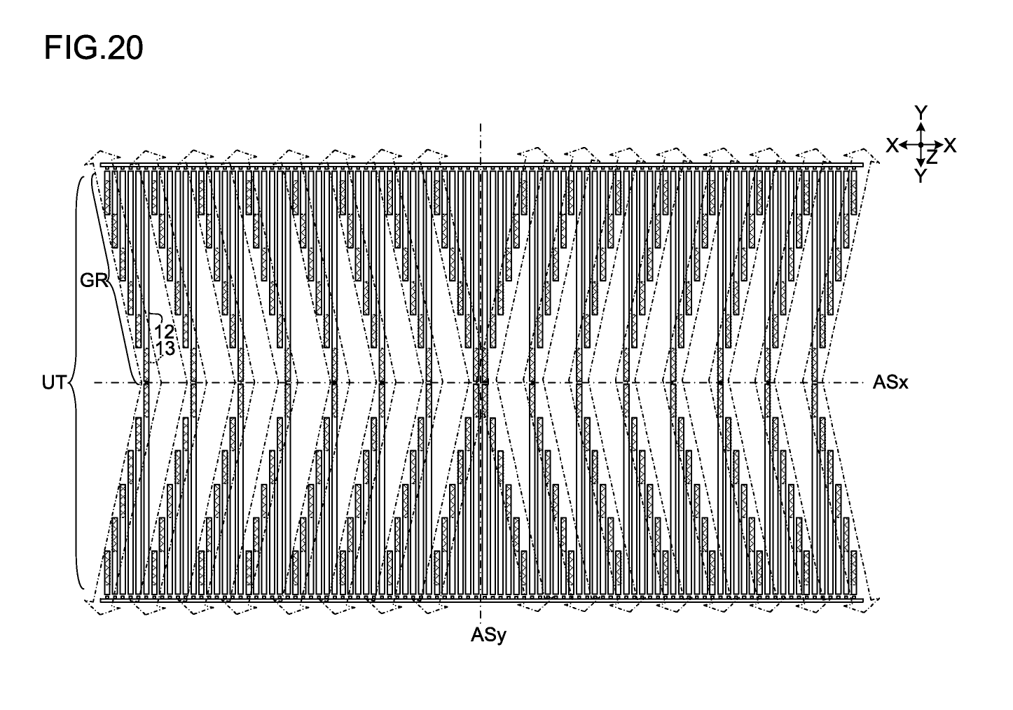

Hence, for example, as shown in the plan view of FIG. 20, the light guide bars 11 (the light guide bar group GR) may be arranged. Specifically, the direction (the Y-direction) of the total length of the light guide bar 11 is perpendicular to the direction (the X-direction) in which the light reception ends 12R of the light guide bars 11 are aligned, and, as in FIG. 15, the light guide bars 11 are symmetrically arranged about a symmetrical axis ASx along the X-direction. However, the backlight unit 49 shown in FIG. 20 differs from the backlight unit 49 shown in FIG. 15 in that there is also a symmetrical axis ASy along the Y-direction, and that the light guide bar group GR is symmetrically arranged about the symmetrical axis ASy.

Specifically, in the X-direction that divides two light guide bar groups GR aligned along the Y-direction into two parts, the symmetrical axis ASx is present; in the Y-direction that divides 16 light guide bar groups GR aligned along the X-direction into two parts, the symmetrical axis ASy is present (in short, the light guide bar groups GR (hence, the light guide bars 11) are arranged symmetrically both in a vertical direction and in a lateral direction. In the arrangement of the light guide bar groups GR shown in FIG. 20, the light guide bar groups GR can also be said to be symmetrically arranged about an intersection point between the two symmetrical axes ASx and AXSy that is a symmetrical center).

In the backlight unit 49 configured as described above, as in FIG. 15, in the light guide bar groups GR opposite each other along the Y direction, the track obtained by connecting the light from the processing portions 13 (hence, the light emission portions 12N) arranged in the side of the top ends 12T of the individual light guide bars 11 is formed in the shape of a broken line (V-shaped) indicated by the arrows of alternate long and short dashed lines. The track of the light in the backlight unit 49 shown in FIG. 20 differs from the track of the light in the backlight unit 49 shown in FIG. 15 in that the bottom (bending point) of the V-shaped broke line faces the symmetrical axis ASy along the Y direction (in the light guide bar group GR, the light guide bar 11 having the longest length is the closest to the symmetrical axis ASy along the Y direction as compared with the other shorter light guide bars 11).

In other words, the bottom of the V-shaped track of the light is close to the symmetrical axis ASy along the Y-direction overlapping the vicinity of the center of the planar light. Consequently, the brightness of the vicinity of the center of the planar light is higher than that of the peripheral areas. Hence, in the backlight unit 49 shown in FIG. 20, the brightness of the liquid crystal display panel 59 is effectively enhanced.

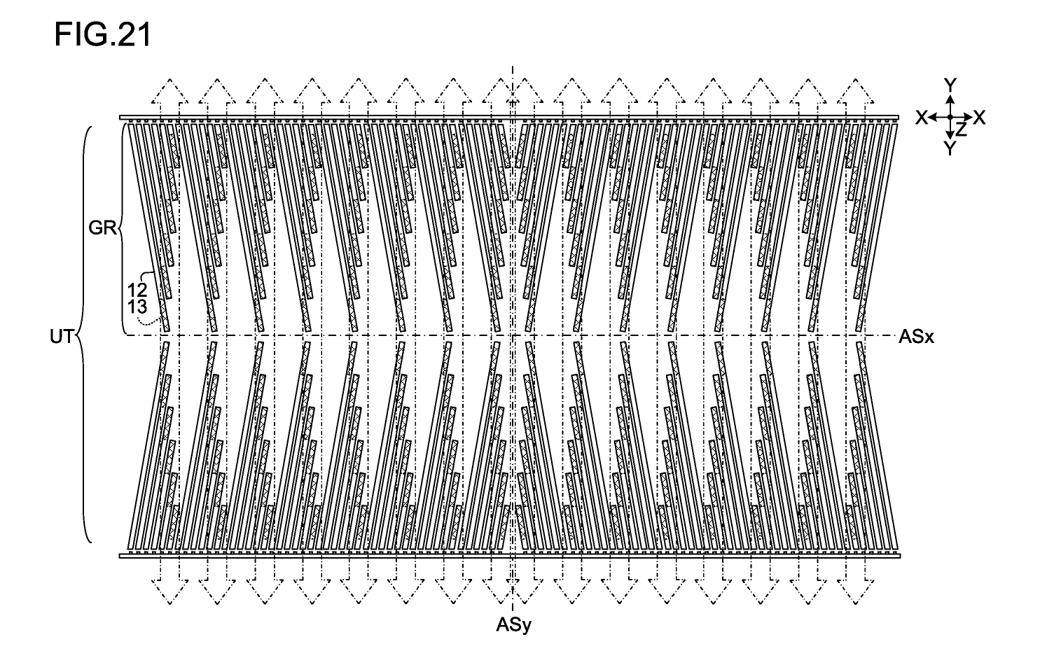

Moreover, for example, as shown in the plan view of FIG. 21, the light guide bars 11 (the light guide bar group GR) may be arranged. Specifically, the light guide bar groups GR (hence, the light guide bars 11) shown in the perspective view of FIG. 16 are arranged, as in FIG. 20, symmetrically both in a vertical direction and in a lateral direction. Specifically, in the X-direction that divides two light guide bar groups aligned along the Y-direction into two parts, the symmetrical axis ASx is present; in the Y-direction that divides 16 light guide bar groups GR aligned along the X-direction into two parts, the symmetrical axis ASy is present. The light guide bar groups GR are symmetrically arranged about both the symmetrical axes ASx and ASy (in the arrangement of the light guide bar groups GR shown in FIG. 21, the light guide bar groups GR can also be said to be symmetrically arranged about the intersection point between the two symmetrical axes ASx and AXSy).

In the backlight unit 49 configured as described above, as in FIG. 17, in the light guide bar groups GR opposite each other along the Y-direction, the track obtained by connecting the light from the processing portions 13 arranged in the side of the top ends 12T of the individual light guide bars 11 is formed in the shape of a straight line indicated by the arrows of alternate long and short dashed lines. The track of the light in the backlight unit 49 shown in FIG. 21 differs from the track of the light in the backlight unit 49 shown in FIG. 17 in that the light guide bars 11 are not spaced regularly, and are arranged close to the symmetrical axis ASy along the Y-direction.

In other words, the straight track of the light is arranged close to the symmetrical axis ASy along the Y-direction overlapping the vicinity of the center of the planar light. Consequently, the brightness of the vicinity of the center of the planar light is higher than that of the peripheral areas. Hence, in the backlight unit 49 shown in FIG. 21, the brightness of the liquid crystal display panel 59 is effectively enhanced.

When, as described above, the arrangement of the light guide bars 11 is either a line-symmetrical arrangement or a point-symmetrical arrangement, the characteristic of the brightness distribution of the planar light is also either a line-symmetrical distribution or a point-symmetrical distribution. Hence, the backlight unit 49 including the light guide bars 11 described above is suitable for local dimming control.

### Fourth Embodiment

A fourth embodiment will be described. Members that have the same functions as in the first to third embodiments are identified with like symbols, and their description will not be repeated.

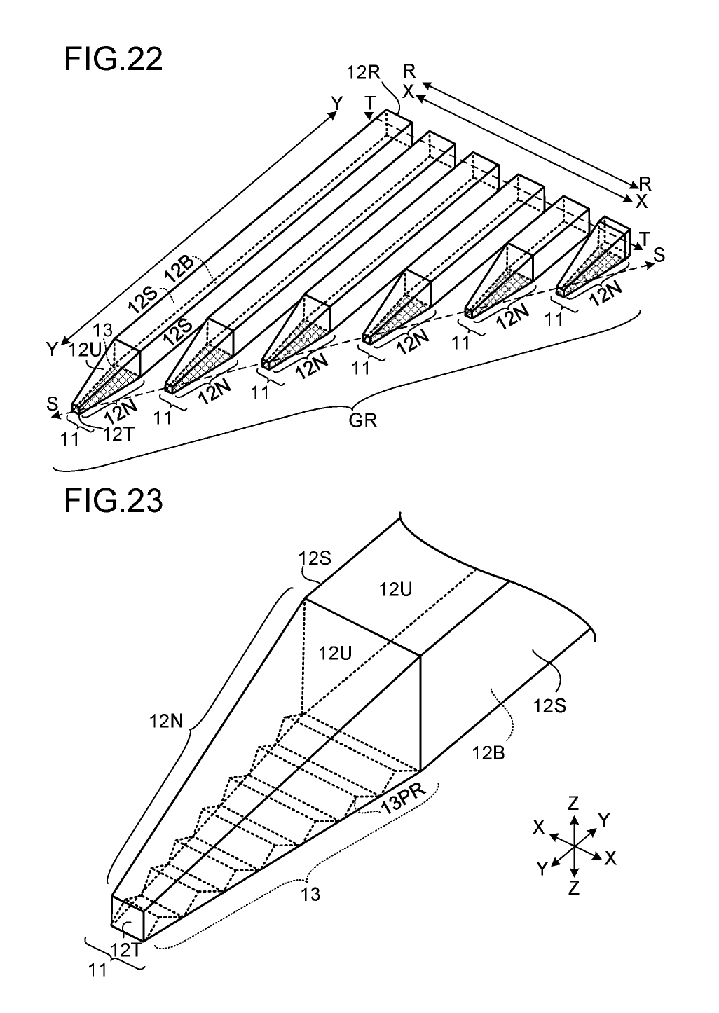

The light guide bar 11 that has been described in the first to third embodiments is a rectangular parallelepiped. However, the shape of the light guide bar 11 is not limited to this shape. For example, as shown in FIG. 22 and FIG. 23 (which is an enlarged view of FIG. 22), the light guide bar 11 may be tapered. For example, the top surface 12U and the side surfaces 12S included in the light emission portion 12N of the light guide bar 11 are inclined, and thus the light emission portion 12N is tapered (the cross-sectional area (the cross-sectional area in the X-Z plane direction) of the light emission portion 12N is decreased as the top end 12T extends farther).

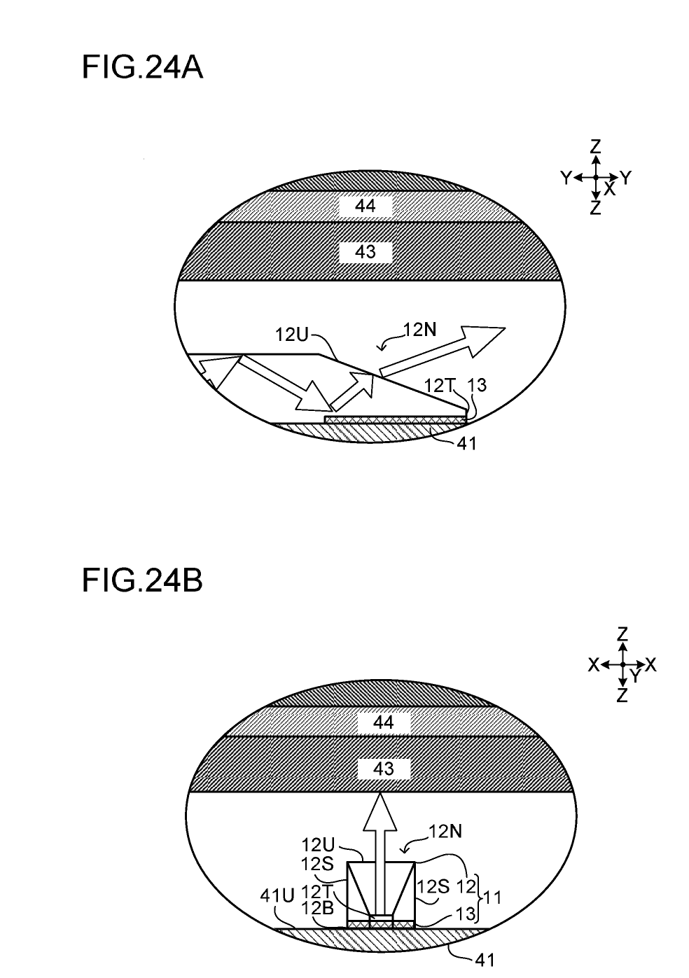

In the light guide bar 11 described above, as shown in FIGS. 24A and 24B, which are cross-sectional views of the light guide bar 11 (the directions in which the cross sections of FIGS. 21A and 21B are taken are the same as those of FIGS. 5A and 5B, respectively; white arrows mean the light), the possibility that, in the light emission portion 12N, the light reaches the processing portion 13 and exits to the outside is increased (when the light reception side of the processing portion 13 faces the diffusion plate 43, the bottom surface 12B that is one of the side surfaces 12S where the processing portion 13 is formed is farthest away from the diffusion plate 43 as compared with the other side surfaces 12S).

Hence, the light is not emitted from the top end 12T of the light guide bar 11, and easily passes through the top surface 12U and reaches the diffusion plate 43 (in other words, light that is unlikely to enter the diffusion plate 43 is not emitted from the light guide bar 11). Consequently, in the backlight unit 49, a bright spot produced by the light emitted from the top end 12T is reduced, and it is possible to obtain planar light (illumination light) having satisfactory evenness.

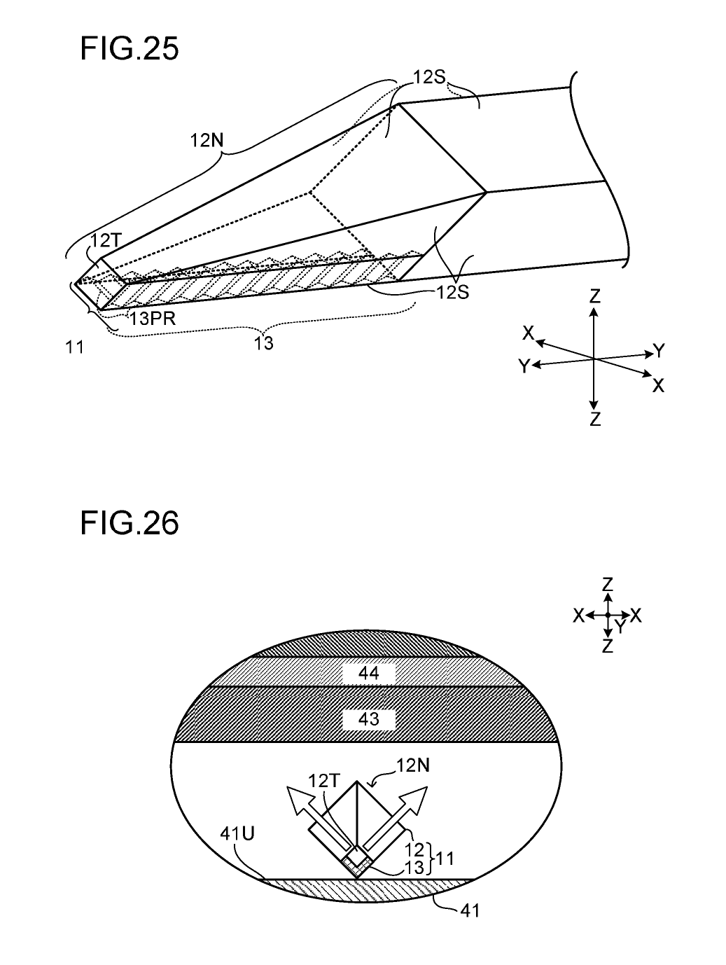

There is a light guide bar 11, other than the light guide bar 11 shown in FIG. 23, that is tapered as shown in FIG. 25 and FIG. 26 (which is a cross-sectional view of FIG. 25). Specifically, in this light guide bar 11, among the four side surfaces 12S, two side surfaces adjacent to each other are inclined, and thus the light emission portion 12N is tapered. Preferably, as shown in FIG. 26, two side surface 12S where the processing portions 13 are formed are separate from the reflective surface 41U of the reflective sheet 41, and the connection portion of the two side surfaces 12S is arranged to face the reflective surface 41U (as shown in FIG. 25, the processing portions 13 have about the same length as the width of the top end 12T of the light guide bar 11, and are formed along the direction in which the side surfaces 12S extend).

In the case where, as described above, the light reception side of the processing portions 13 faces the diffusion plate 43, when the two side surfaces 12S where the processing portions 13 are formed are farthest away from the diffusion plate 43 as compared with the other side surfaces 12S, in the optical path of the light (see white arrows) of FIG. 26, as compared with that of FIG. 9, the optical path extending from the processing portions 13 to the diffusion plate 43 is made longer. Consequently, the planar light shone on the diffusion plate 43 becomes light that is obtained by overlapping the light from a plurality of light guide bars 11 in a widespread area and that has no variations in the amount of light, and the quality of the backlight is enhanced (in the liquid crystal display device 69 shown in FIGS. 24B and 26, the distance from the diffusion plate 43 to the processing portion 13 of the light guide bar 11 is longer than the distance from the reflective sheet 41 to the processing portion 13).

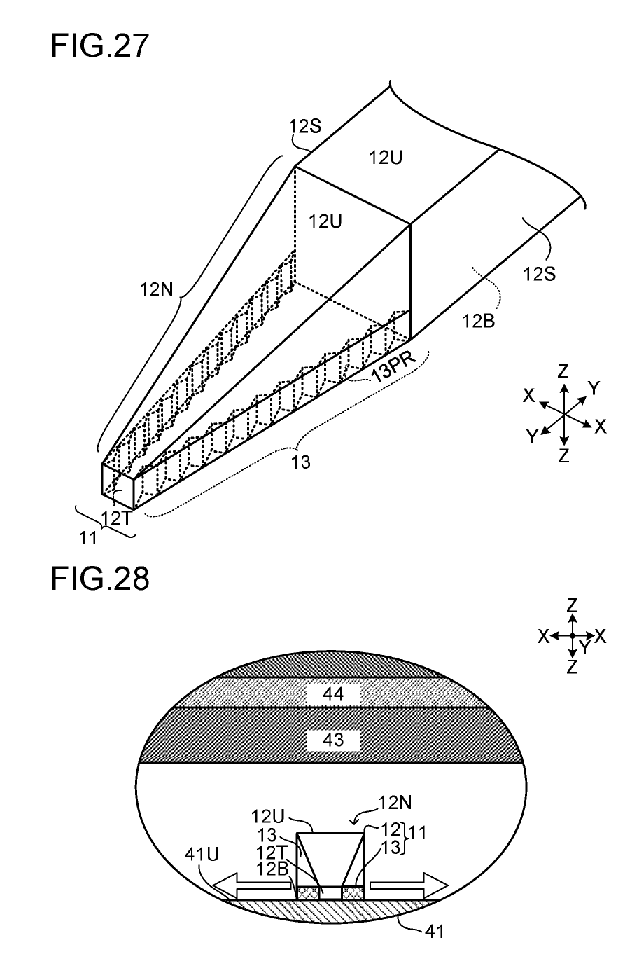

For example, as shown in FIG. 27 and FIG. 28 (which is a cross-sectional view of FIG. 27), in at least part of the side surfaces 12S opposite each other, the processing portion 13 may be formed. Specifically, the processing portion 13 is formed such that its height is substantially equal to the height (the width of the top end 12T of the light guide bar 11) of the top end 12T of the light guide bar 11, and is formed along the direction in which the side surface 12S of the light emission portion 12N extends.

Since, in the light guide bar 11 described above, as compared with the light guide bar 11 shown in FIG. 10, the processing portions 13 formed in the side surfaces 12S are farthest away from the diffusion plate 43, in the optical path of the light (see white arrows) of FIG. 28, as compared with that of FIG. 10, the optical path extending from the processing portion 13 to the diffusion plate 43 is made longer. Consequently, the light becomes light that is obtained by further overlapping the light from a plurality of light guide bars 11 in a widespread area and that has no variations in the amount of light, and the quality of the backlight is enhanced.

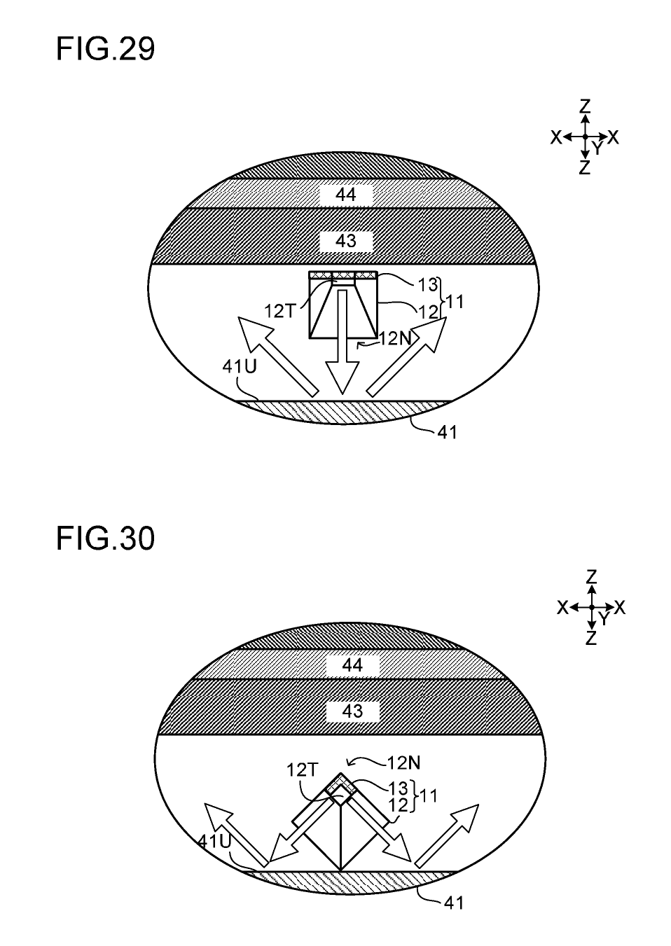

In the light guide bar 11 shown in FIG. 24B, as shown in FIG. 29, the processing portion 13 is planar, and the light reception side (the light reception surface) of the surface may face the reflective sheet 41 (specifically, the reflective surface 41U) (in particular, the distance from the reflective sheet 41 to the processing portion 13 of the light guide bar 11 is longer than the distance from the diffusion plate 43 to the processing portion 13). In the case where, as described above, the light reception side of the processing portion 13 faces the reflective sheet 41, when the one of the side surfaces 12S where the processing portion 13 is formed is farthest away from the reflective sheet 41 as compared with the other side surfaces 12S, the light (see white arrows) of FIG. 29 travels, as in FIG. 11, from the processing portion 13 toward the reflective sheet 41, is reflected off the reflective sheet 41 and then reaches the diffusion plate 43. Hence, the optical path extending from the processing portion 13 to the diffusion plate 43 is reliably made longer, and consequently, the light becomes light that is obtained by overlapping the light from a plurality of light guide bars 11 in a widespread area and that has no variations in the amount of light, and the quality of the backlight is enhanced.

Preferably, in the light guide bar 11 shown in FIG. 30, as shown in FIG. 12, the surfaces (light reception surfaces) of the processing portions 13 face the reflective sheet 41, and the two side surfaces 12S where the processing portions 13 are formed are separated from the diffusion plate 43 of the reflective sheet 41, and the connection portion of the two side surfaces 12S is arranged to face (approach) the diffusion plate 43 (when the light reception side of the processing portion 13 faces the reflective sheet 41, the two surfaces of the side surfaces 12S where the processing portions 13 are formed are farthest away from the reflective sheet 41 as compared with the other side surfaces 12S). This because, even in this configuration, the optical path extending from the processing portion 13 to the diffusion plate 43 is reliably made longer (the distance from the reflective sheet 41 to the processing portion 13 of the light guide bar 11 is longer than the distance from the diffusion plate 43 to the processing portion 13).

### Fifth Embodiment

A fifth embodiment will be described. Members that have the same functions as in the first to fourth embodiments are identified with like symbols, and their description will not be repeated.

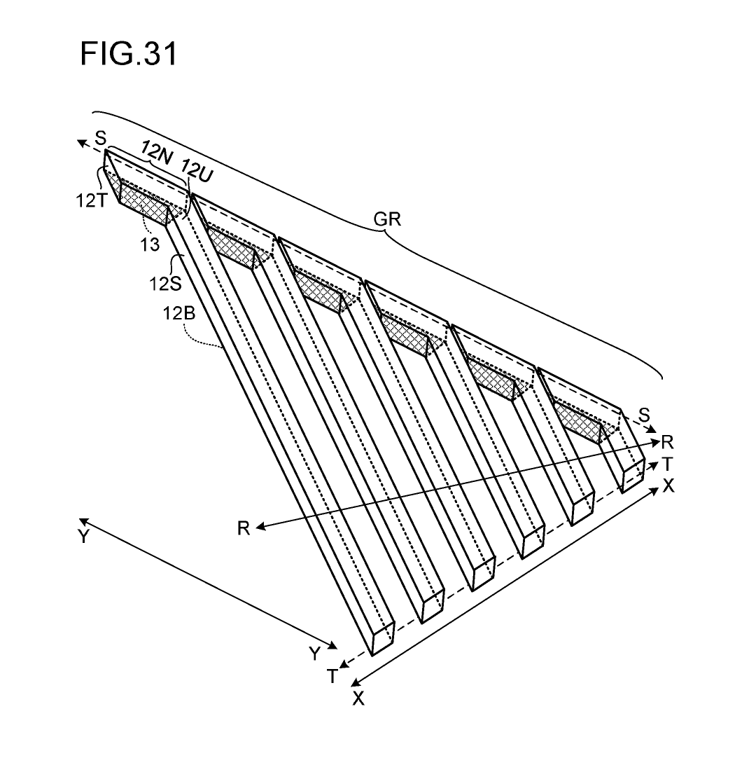

In the fourth embodiment, the light guide bar 11 including the straight and tapered light emission portion 12N has been described. However, the shape of the tapered light guide bar 11 is not limited to the straight shape. For example, as shown in FIG. 31, the light guide bar 11 may be bent.

Specifically, the light guide bar 11 is bent, and the processing portion 13 is included in a portion extending from the bent place to the top end 12T. The direction in which the light emission portion 12N including the processing portion 13 extends (in short, the direction from the bent place to the top end 12T) intersects, in the light guide bar group GR, the R-direction in which the light guide bars 11 are aligned and is also perpendicular to the light reception end arrangement line T formed by connecting the positions of the light receiving ends 12R.

Moreover, in the light guide bar group GR, a plurality of linear light emission portions 12N are arranged such that they are perpendicular to the light reception end arrangement line T and are continuous. Hence, the light emission portion arrangement line S formed by connecting the light emission portions 12N is also perpendicular to the light reception end arrangement line T.

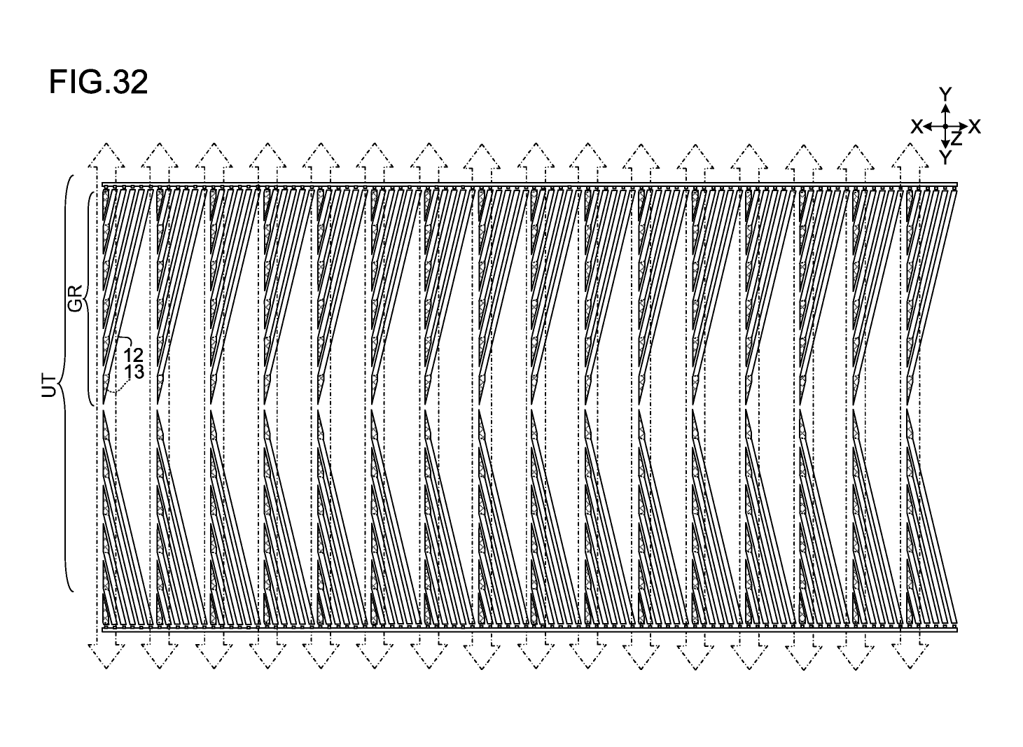

In the light guide bar group GR described above, the light emission portion arrangement line S coincides with the direction in which the light emission portions 12N extend. Hence, as shown in FIG. 32, which is a plan view obtained by aligning a plurality of light guide bar groups GR shown in FIG. 31, a track obtained by connecting light from the light emission portions 12N reliably becomes linear, as indicated by the arrows of alternate long and short dashed lines.

Since, in the backlight unit 49 including the light guide unit UT shown in FIG. 32, as shown in FIG. 17, the light (see the arrows of alternate long and short dashed lines) of the backlight unit 49 is not displaced, the backlight is unlikely to have variations in the amount of light.

### Sixth Embodiment

A sixth embodiment will be described. Members that have the same functions as in the first to fifth embodiments are identified with like symbols, and their description will not be repeated.

In the light guide unit UT of the first to fifth embodiments, the area of the processing portion 13 of each of the light guide bars 11 is constant. However, the present invention is not limited to this configuration.

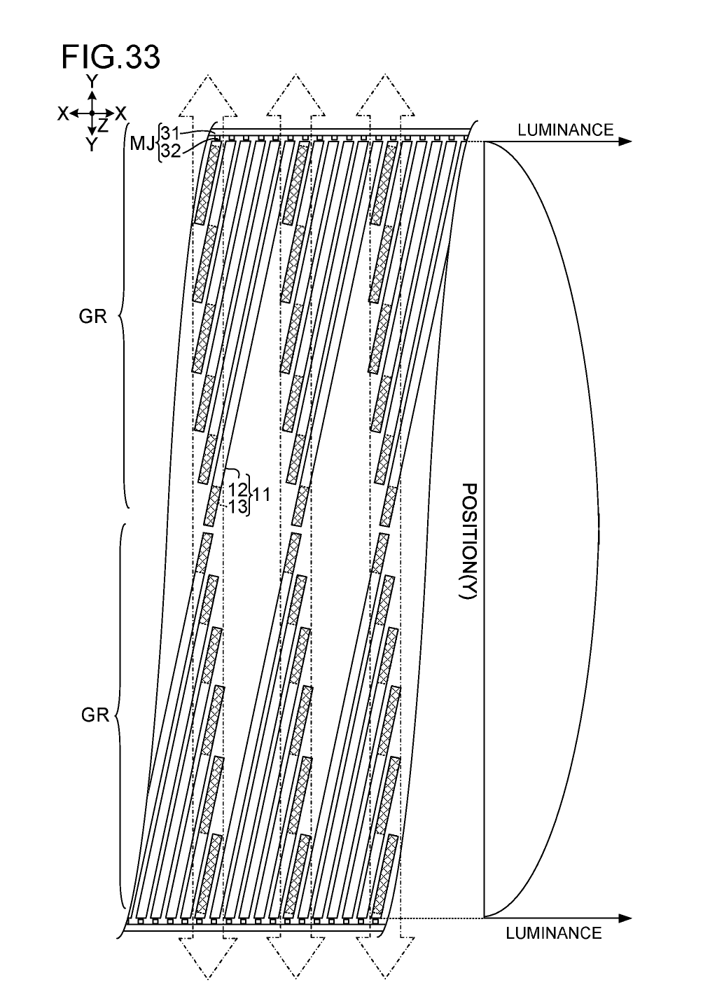

For example, as shown in the plan view of FIG. 33, in the light guide unit UT, as the total length of the light guide bar 11 becomes longer, the area of the processing portion 13 may become smaller. In this configuration, when a plurality of LEDs 32 are equal in the brightness of light emission, the brightness of the light from the light guide bar 11 (specifically, the brightness per unit area of the processing portion 13) is inversely proportional to the area of the processing portion 13. Specifically, as the light guide bar 11 having a longer total length, the area of the processing portion 13 is reduced, and the brightness of the light from the side of the end of the light guide bar 11 is increased.

Hence, as shown in a brightness distribution diagram (the brightness distribution diagram showing the relationship between the positions in the Y-direction and the brightness) illustrated next to the plan view of FIG. 33, the vicinity of the center between the mounting substrates 31, that is, the vicinity of the center of the liquid crystal display panel 59 (in short, the vicinity of the center of the liquid crystal display panel 59 when the light reception end arrangement line T is overlapped with the longitudinal side of the rectangular liquid crystal display panel 59) is brighter than the vicinity of the ends along the longitudinal direction of the liquid crystal display panel 59.

In this way, because of visual characteristics, for example, the user is unlikely to notice the darkness in the vicinity of the ends along the longitudinal direction of the liquid crystal display panel 59. Hence, when the light guide unit UT described above is incorporated in the liquid crystal display device 69, it is possible to provide a satisfactory image to the user while reducing the power consumption of the LEDs 32.

Since the backlight unit 49 incorporating the light guide unit UT can perform local dimming, it is possible to partially control the amount of light according to an image displayed on the liquid crystal display panel 59. Hence, needless to say, the power consumption is effectively reduced. Since the backlight unit 49 controls the backlight in synchronization with the image displayed on the liquid crystal display panel 59, it is also possible to enhance the moving image display performance of the liquid crystal display device 69.

FIG. 15 is the enlarged view of the light guide unit UT having a point-symmetrical arrangement. However, the light guide unit UT in which the areas of the processing portions 13 are different is not limited to the light guide unit UT having a point-symmetrical arrangement; it is needless to say that it can be the light guide unit UT shown in FIG. 15 and having a line-symmetrical arrangement.

### Other Embodiments

The present invention is not limited to the embodiments described above; many modifications are possible without departing from the spirit of the present invention.

Although, in the above description, the holding member 25 has a plurality of grooves 26D, the present invention is not limited to this configuration. For example, when the backlight unit 49 incorporates only one light guide bar 11, the holding member 25 has only one groove 26D (in other words, in the above description, since a plurality of light guide bars 11 are used, it is also said that, for ease of handling, the holding members 25 having one groove 26D are continuous).

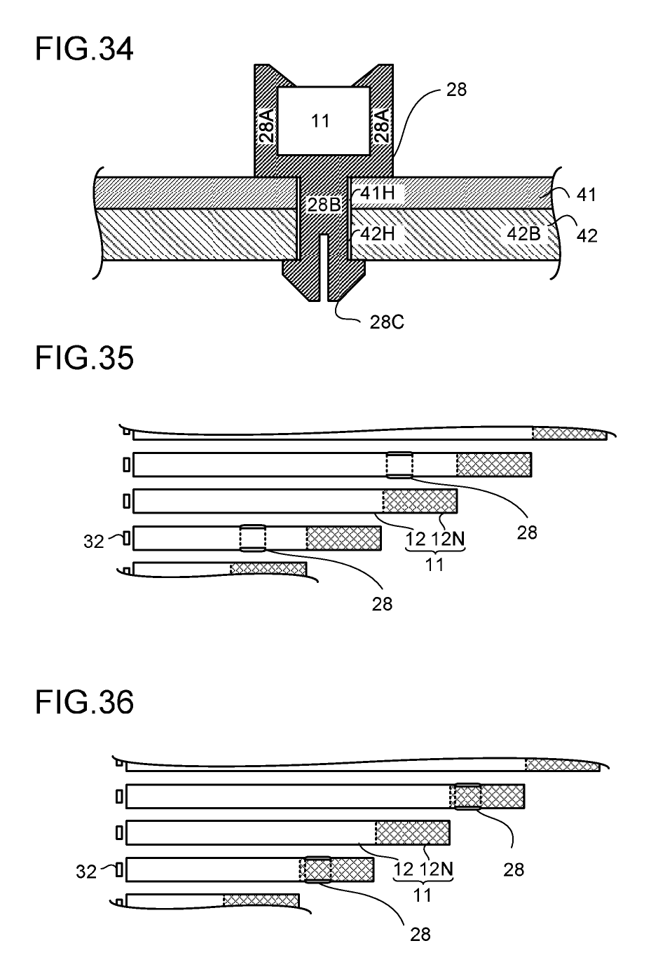

As shown in the cross-sectional view of FIG. 34, a clip 28 for retaining the light guide bar 11 may be attached to the bottom surface 42B of the backlight chassis 42 (the clip 28 is preferably formed of the same reflective resin as the holding member 25). Specifically, the clip 28 includes a retaining part 28A for retaining the light guide bar 11, a support shaft part 28B for supporting the retaining part 28A and a hook part 28C that is connected to a top end of the support shaft part 28B.

The retaining part 28A is a ring-shaped member that catches the light guide bar 11 and that includes a cut. The support shaft part 28B is a shaft that is continuous to the vicinity of the bottom of the ring-shaped retaining part 28A. The hook part 28C is a member that is hooked on the edge of an opening hole 42H of the backlight chassis 42 and thus the support shaft part 28B (hence, the clip 28) is made to rise from the bottom surface 42B of the backlight chassis 42 (in the reflective sheet 41, a sheet opening hole 41H that covers the opening hole 42H formed in the bottom surface 42B of the backlight chassis 42 is formed, and the hook part 28C is fitted to the opening hole 42H through the sheet opening hole 41H).

Since the clips 28 described above are included in the light guide set ST (set in which the LEDs 32, the light guide bars 11 and the holding member 25 are integral), the light guide bars 11 are more stably fixed to the backlight chassis 42. The position of the clip 28 is not particularly limited; for example, as shown in FIG. 35, the portions of the light guide bar 11 other than the light emission portion 12N may be retained by the clip 28; as shown in FIG. 36, the light emission portion 12N of the light guide bar 11 may be retained (however, when the clip 28 retains the portions other than the light emission portion 12N, the travel of the light is unlikely to be blocked by the clip 28).

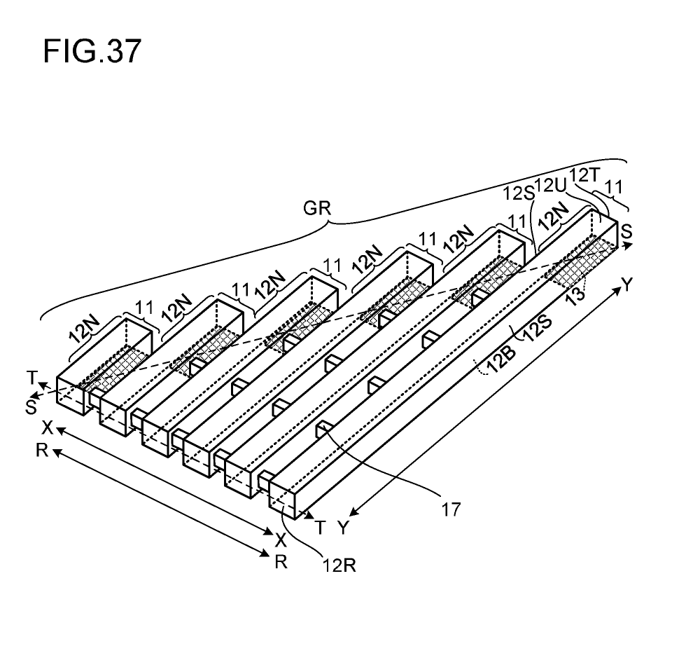

For example, as shown in FIG. 37, coupling members 17 are present between the side surface 12S of the light guide bars 11, and thus the light guide bars 11 are connected, with the result that the light guide bar group GR may be formed. In this way, in the manufacturing of the backlight unit 49, it is possible to eliminate a bothersome in which the light guide bar group GR and hence the light guide unit UT are formed by individually aligning the light guide bars 11. In other words, the light guide unit UT is completed only by aligning the light guide bar groups GR.

The manufacturing of the light guide bar group GR including the coupling members 17 is not particularly limited. For example, a mold in which cuts of the shapes of the coupling members 17 are formed is used, and thus integral molding (such as injection molding) may be performed; alternatively, separate light guide bars 11 may be coupled using the coupling members 17 and an adhesive or the like.

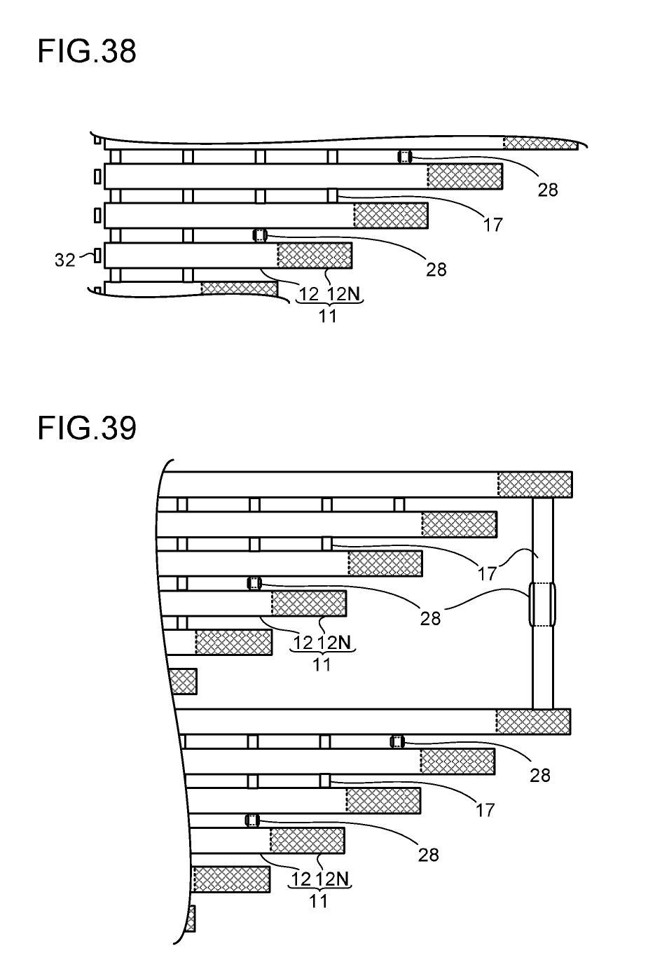

As shown in FIG. 38, the clip 28 may be connected to the coupling member 17. Even when, as shown in FIG. 39, the coupling member 17 connects a plurality of light guide bar groups GP, the clip 28 may be connected to the coupling member 17.

The clip 28 retains the light guide bar 11 (the light guide bar group GP) that is likely to thermally expand by receiving the heat of the LEDs 32 or the other circuit components. Hence, the clip 28 preferably retains the light guide bar 11 such that the movement of the light guide bar 11 thermally expanding is not prevented. For example, as shown in FIGS. 35 and 36, the retaining part 28A is preferably in contact along the direction in which the light guide bars 11 extend.

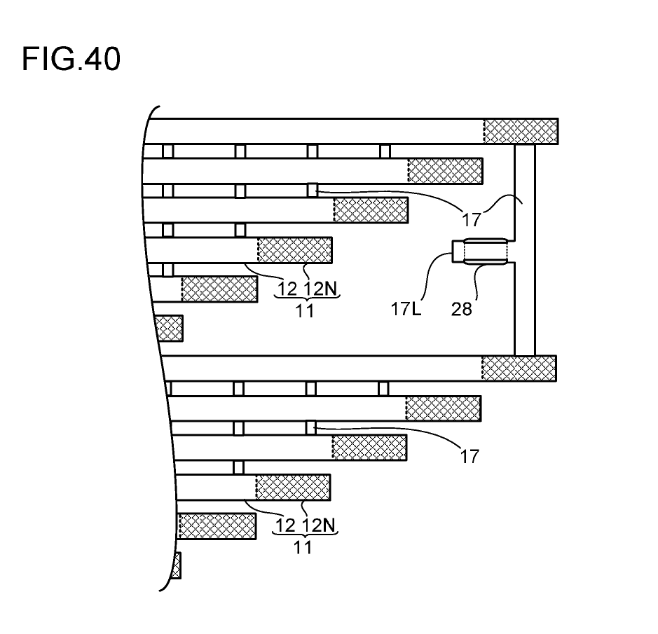

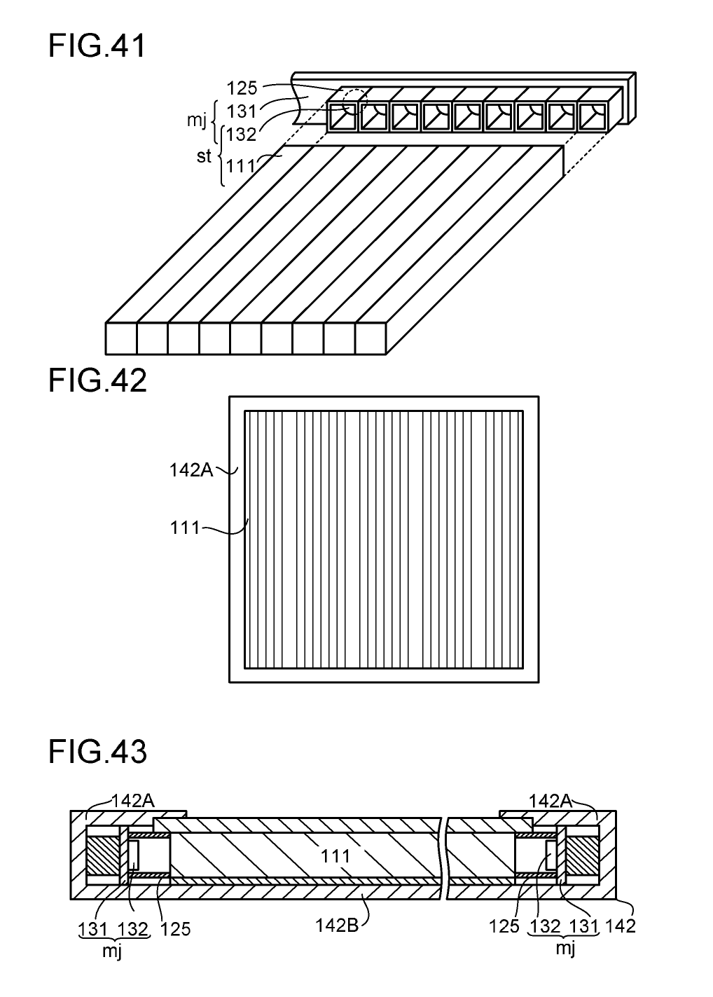

Hence, in order for the retaining part 28A to be prevented from making contact along the coupling member 17 that intersects the direction in which the light guide bars 11 extend (see FIGS. 38 and 39), as shown in FIG. 40, the retaining part 28A preferably supports the light guide bar group GP. Specifically, a part member 17L along the direction in which the light guide bars 11 extend is connected to the coupling member 17, and the retaining part 28A preferably catches the part member 17L. In this way, for example, even if the light guide bar 11 extends by the heat of the LEDs 32, the clip 28 reliably catches the part member 17L, and hence stably retains the light guide bar group GP.

The type of LED 32 is not particularly limited. For example, as an example of the LED 32, there is an LED that includes a blue light emitting LED chip (a light emitting chip) and a fluorescent member which receives light from the LED chip to emit yellow light (the number of LED chips is not particularly limited). This type of LED 32 generates white light using the light from the blue light emitting LED chip and the light of the fluorescent emission.

However, the fluorescent member incorporated in the LED 32 is not limited to the yellow light emitting fluorescent member. For example, the LED 32 may include a blue light emitting LED chip and a fluorescent member which receives light from the LED chip to emit green light and red light; this LED 32 may generate white light using the blue light from the LED chip and the light (green light/red light) of the fluorescent emission.

The LED chip incorporated in the LED 32 is not limited to the blue light emitting LED chip. For example, the LED 32 may include a red light emitting red LED chip, a blue light emitting blue LED chip and a fluorescent member which receives light from the blue LED chip to emit green light. This is because this type of LED 32 can generate white light using the red light from the red LED chip, the blue light from the blue LED chip and the green light of the fluorescent emission.

The LED 32 containing no fluorescent member may be used. For example, the LED 32 may include a red light emitting red LED chip, a green light emitting green LED chip and a blue light emitting blue LED chip, and may generate white light using the light from all the LED chips.

The light emitted from the individual light guide bars 11 is not limited to white light; red light, green light and blue light may be emitted. The light guide bars 11 that emit red light, green light and blue light are arranged as close to each other as possible to generate white light by the mixing of the light (for example, the light guide bar 11 emitting red light, the light guide bar 11 emitting green light and the light guide bar 11 emitting blue light are arranged adjacent to each other).

Needless to say, embodiments obtained by combining the technologies disclosed above as necessary are also included in the technical scope of the present invention.

### LIST OF REFERENCE SYMBOLS

21 support stage
25 holding member
26 first holding member part
26D groove
26Db groove bottom
26Dh opening hole formed in the groove bottom (first engagement portion/second engagement portion)
26Ds groove wall
27 second holding member part
28 clip
11 light guide bar (light guide member)
11P protrusion formed on the light guide bar (second engagement portion/first engagement portion)
12 light propagation portion of the light guide bar
12R light reception end of the light guide bar
12T top end of the light guide bar
12S side surface of the light guide bar
12B bottom surface that is one of the side surfaces of the light guide bar
12U top surface that is one of the side surfaces of the light guide bar
T light reception end arrangement line
12N light emission portion
13 processing portion (optical path change processing portion)
13PR triangular prism
S processing portion arrangement line (light emission portion arrangement line)
15 lens
17 coupling member
17L part member
31 mounting substrate
31U mounting surface
32 LED (light source, light emitting element)
MJ LED module
X direction in which the mounting substrates extend
Y direction in which the mounting substrates are aligned
Z direction intersecting the X-direction and the Y-direction
R direction in which the light guide bars are aligned
41 reflective sheet
41U reflective surface
42 backlight chassis (chassis)
43 diffusion plate
44 prism sheet
45 lens sheet
49 backlight unit (illumination device)
59 liquid crystal display panel (display panel)
69 liquid crystal display device (display device)

1. A light guide set comprising:
a light source;
a light guide bar that includes a light reception end receiving light from the light source and that guides the received light; and
a holding member that holds the light source and a side of the light reception end of the light guide bar,
wherein, among a first engagement portion and a second engagement portion that engage with each other, one of the engagement portions is formed in the light guide bar, and the other engagement portion is formed in the holding member.

2. The light guide set of claim 1,
wherein the first engagement portion and the second engagement portion are also fitting portions that fit each other, and one of the engagement portions is convex, and the other engagement portion is so concave as to fit the convex engagement portion.

3. The light guide set of claim 1,
wherein the holding member has a hollow, and the light source and a part of the light guide bar are held within the hollow.

4. The light guide set of claim 3,
wherein the first engagement portion and the second engagement portion engage with each other such that the light reception end is separated from the light source placed at an end of the hollow of the holding member.

5. The light guide set of claim 1,
wherein the holding member is an aggregation of a plurality of holding member parts, and
the light source and the light guide bar are held in the holding member by being sandwiched between the holding member parts.

6. The light guide set of claim 1, further comprising:
a clip that retains the light guide bar.

7. The light guide set of claim 6,
wherein the light guide bar includes:
a light propagation portion that propagates the received light by reflecting the received light multiple times therewithin; and
a light emission portion that emits the propagated light to an outside, and the clip retains the propagation portion or the light emission portion.

8. The light guide set of claim 1,
wherein, when a plurality of the light guide bars are provided, the light guide bars are coupled to each other through a coupling member.

9. The light guide set of claim 8, further comprising:
a clip that retains the coupling member.

10. The light guide set of claim 8,
wherein a part member along a direction in which the light guide bars extend is connected to the coupling member, and
the clip catches the part member.

11. The light guide set of claim 1,
wherein, when a plurality of the light guide bars are provided, the holding members are integrally continuous.

12. An illumination device comprising:
the light guide set of claim 1; and
a chassis that holds the light guide set.

13. The illumination device of claim 12, further comprising:
a diffusion plate that is supported by a surface of the holding member and that receives light from the light guide set; and
an optical member that is supported by the diffusion plate and that transmits light from the diffusion plate.

14. The illumination device of claim 13,
wherein the holding member engages with the chassis and the clip also engages with the chassis such that the light guide bar is prevented from moving with respect to the chassis.

15. A display device comprising:
an illumination device of claim 12; and
a display panel that receives light from the illumination device.
